(19) United States
(12) Patent Application Publication
(10) Pub. No.: US 2012/0116963 A1
(43) Pub. Date: May 10, 2012

(54) Invoicing and electronic billing system and method

(75) Inventors: Charmaine Klein, Charlotte, NC (US); Mark D. Zanzot, Huntersville, NC (US)

(73) Assignee: Bank of America Corporation, Charlotte, NC (US)

(21) Appl. No.: 13/200,260

(22) Filed: Sep. 22, 2011

Related U.S. Application Data
(60) Provisional application No. 61/507,943, filed on Jul. 14, 2011.
(60) Provisional application No. 61/410,087, filed on Nov. 4, 2010.
(60) Provisional application No. 61/410,085, filed on Nov. 4, 2010.

(51) Int. Cl. G06Q 40/00

(52) U.S. Cl. 705/40

(57) ABSTRACT

Systems, methods, and computer program products are provided for invoicing and electronic billing. Methods include receiving invoicing data from a merchant, identifying a user based on the invoice data, receiving payment instructions from the user, where the payment instructions include an alias, and determining that the merchant is a registered payment recipient based on the alias. In specific embodiments, the invoice data is converted into an electronic bill, and the electronic bill is sent to the user.

### CROSS-REFERENCE TO RELATED APPLICATIONS

This application claims priority to U.S. Provisional Application Ser. Nos. 61/507,943 entitled “Invoicing and Electronic Billing System and Method” filed Jul. 14, 2011, 61/410,087 entitled “Online Payment System and Method” filed Nov. 4, 2010, and 61/410,085 entitled “Mobile Payment System and Method” filed Nov. 4, 2010, the contents of which are incorporated herein in their entirety.

### BACKGROUND

Many customers prefer a convenient and secure method to pay bills. Payment methods such as credit cards, debit cards, and online banking may offer some convenience; however, some customers do not have access to these payment methods or may be reluctant to use them. Although cash and checks are more conventional, these payment methods can be very inconvenient and time consuming depending on the situation.

Money can be transferred from one account to other using electronic banking systems, but these systems traditionally require that the sender know account information for the receiver in order to instruct the bank to transfer money to the proper account. Most people do not know the account numbers of their friends or businesses they patronize, nor do most people want to widely publicize their account numbers for security reasons.

There thus is a need for improved user-friendly systems and methods for invoicing and electronic billing.

### BRIEF SUMMARY

Embodiments of the present invention address these and/or other needs by providing an innovative invoicing and electronic billing system along with a user-friendly interface and process for sending and receiving payments. Embodiments of the invention enable merchants to manage invoices, send electronic bills, and receive and transfer payments conveniently and securely. Advantageously, embodiments of the invention do not necessarily require users to share confidential account information with others in order to send and receive payments. In fact, embodiments of the invention do not require that the payment sender know any information about the financial accounts of the intended payment recipient. Furthermore, embodiments of the invention enable users to attempt to make payments to merchants that are not customers of the same financial institution and to merchants that are not customers of any financial institution. Embodiments of the invention also create a “viral” account opening and payment system registration process whereby one person's use of the system encourages others to use the system.

More specifically, embodiments of the invention allow an entity to transfer funds to another entity using a mobile telephone number, electronic mail (email) address, and/or other alias of the transfer recipient. The assignee of the present application describes some embodiments of such an invention in U.S. Provisional Patent Application No., 60/991,172, filed on Nov. 29, 2007, and co-pending U.S. patent application Ser. No. 12/038,177, filed on Feb. 27, 2008, U.S. Provisional Patent Application No. 61/410,085 filed on Nov. 4, 2010, and U.S. Provisional Patent Application No. 64/410,087 filed on Nov. 4, 2010, as well as in U.S. patent application Ser. Nos. 12/881,071, 12/881,073, 12/881,074, and 12/881,080 continuing therefrom; the contents of which are incorporated herein by reference. Embodiments of the present invention include and build off of those earlier embodiments to provide an improved P2P payment system and a more user-friendly, secure, and convenient user interface and method.

Embodiments of the invention also provide a user interface that makes it easy for users to monitor their current, future, pending, and past person-to-person (P2P) and/or person-to-merchant (P2M) funds transfers as well as their saved transfer recipient list, alias registrations, incoming transfers, and/or other related information.

It should be appreciated that at least some embodiments of the invention provide a more convenient, user friendly, and secure P2P payment system because it is provided by the user's bank, through the bank's online banking system with which the user is already familiar. In at least some embodiments, the user may not need to share personal or confidential information, such as account information, with people or businesses outside of the user's bank. The user can feel more secure having P2P payment services handled by their bank and having the convenience of being able to directly send money from and/or receive money into the user's one or more financial institution accounts.

In some embodiments, a method of invoicing and payment is provided. The method comprising: storing an alias for a merchant in a storage device; storing in the storage device at least one invoice associated with the merchant, where the invoice is directed for payment by a user; and associating the alias of the merchant with the at least one invoice via a computing device processor, such that the payment may be remitted to the merchant by reference to the alias. In some embodiments, the method further comprising: receiving payment instructions from the user, wherein the payment instructions include the alias for the merchant. In other embodiments, the method further comprising: determining, via a computer device processor, that the merchant is a registered payment recipient based on the alias; and applying the payment to the invoice. In still other embodiments, the method further comprising transmitting information associated with the invoice to the user, receiving payment instructions from the user, wherein the payment instructions include the alias for the merchant; and applying the payment to the invoice. The method further including: communicating, via a computing device, a payment notification to the merchant based on the merchant being the registered payment recipient.

In some embodiments, the method further comprises: determining that the alias is associated with a registered bank account of the merchant. In other embodiments, the alias comprises an identifier selected from the group consisting of: a mobile telephone number, an email address, a social networking ID, a name, an address, a URL address, a logo, a brand, a picture, graphical art, a trade name, a trade mark, or combinations thereof. In still other embodiments, the method further comprises: receiving a search term from the merchant; matching, via a computing device processor, the search term with the at least one invoice in the storage device; identifying, via a computing device processor, the user based on the at least one invoice.

In some embodiments, the method further comprises: identifying, via a computing device processor, one or more additional users; and presenting a list of the additional users to the merchant. In other embodiments, the invoice comprises data selected from the group consisting of: product identification; quantity of items ordered; price of each item; fees for services or products; tax amounts; total amount due; date payment is due; payment history; explanation of fees; explanation of services; shipping information, or combinations thereof.

According to some embodiments of the invention, another method is provided. The method comprising: receiving, via a computing device, invoice data from a merchant; identifying, via a computing device processor, a user based on the invoice data, wherein the user is associated with a payment; sending information associated with the invoice data to the user and receiving payment instructions from the user, wherein the payment instructions include an alias; and determining, via a computing device processor, that the merchant is a registered payment recipient based on the alias.

In some embodiments of the method, the method further comprises determining, via a computing device processor, that the user owes the merchant a payment amount; presenting an invitation to the user to transfer a payment amount to the merchant; and communicating, via computing device, a payment notification to the merchant. In other embodiments, the method further comprises: determining, via a computing device processor, that the merchant owes the user a payment amount; receiving payment instructions from the merchant, wherein the payment instructions include an alias associated with the user; determining, via a computing device processor, that the user is a registered payment recipient based on the alias; and communicating, via a computing device, a payment notification to the user. In still other embodiments, wherein the payment amount is associated with a rebate amount that is owed to the user.

In some embodiments of the method, the payment instructions comprises a payment amount, the method further comprising determining that the payment amount is below a maximum amount. In some embodiments, the method further comprises: determining that the alias is associated with one or more accounts. In other embodiments, the method further comprises: transferring a payment amount to the one or more accounts.

In some embodiments of the method, the alias comprises an identifier selected from the group consisting of: a mobile telephone number, an email address, a social networking ID, a name, an address, a URL address, a logo, a brand, a picture, graphical art, a trade name, a trade mark, or combinations thereof. In other embodiments, the method further includes: converting, via a computing device processor, the invoice data into an electronic bill; sending the electronic bill to an identified user; and transferring a payment to one or more accounts associated with the merchant.

In some embodiments, a computer program product is provided. The computer program product comprising a computer-readable medium having computer-executable instructions for performing: storing an alias for a merchant in a storage device; storing at least one invoice associated with the merchant in the storage device, where the invoice is directed for payment by a user; and associating the alias of the merchant with the at least one invoice via a computing device processor, such that a payment may be remitted to the merchant by reference to the alias. In some embodiments, the computer-executable instructions further perform: receiving payment instructions from the user, wherein the payment instructions include the alias for the merchant.

In some embodiments of the computer program product, the computer-executable instructions further perform: determining that the merchant is a registered payment recipient based on the alias; and communicating a payment notification to the payment recipient based on the payment recipient being the registered payment recipient. In other embodiments, the computer-executable instructions further perform: transmitting information associated with the invoice to the user; receiving payment instructions from the user, wherein the payment instructions include the alias for the merchant; and applying the payment to the invoice.

In some embodiments of the computer program product, the invoice data comprises a bar code. In other embodiments, the computer-executable instructions further perform: scanning the bard code; and retrieving data from the at least one invoice based on the bar code. In other embodiments, the computer-executable instructions further perform: matching the alias with an account associated with the merchant, and transferring a payment amount to the account. In still other embodiments, the alias comprises an identifier selected from the group consisting of: a mobile telephone number, an email address, a social networking ID, a name, an address, a URL address, a logo, a brand, a picture, graphical art, a trade name, a trade mark, or combinations thereof.

In some embodiments, the payment instructions comprise a payment amount. In some embodiments of the computer program product, the computer-executable instructions further perform: determining that the payment amount is below a maximum amount; and communicating a payment notification to the merchant, wherein the payment notification comprises the payment amount. In other embodiments, the computer-executable instructions further perform: determining that one or more account are associated with the alias; tracking payment transfers associated with the one or more accounts; and storing records of the payment transfers in the storage device

In some embodiments, a system for electronic billing is provided. The system comprising a computer apparatus including a processor and a memory; and an electronic billing module stored in the memory, executable by the processor and configured to: store an alias for a merchant in a storage device; store at least one invoice associated with the merchant in the storage device, where the invoice is directed for payment by a user; and associate the alias of the merchant with the at least one invoice via a computing device processor, such that a payment may be remitted to the merchant by reference to the alias.

In some embodiments of the system: the module is further configured to: receive payment instructions from the user, wherein the payment instructions include the alias for the merchant. In other embodiments, the module is configured to: determine that the merchant is a registered payment recipient based on the alias; communicate a payment notification to the merchant based on the merchant being the registered payment recipient; and apply the payment to the invoice. In still other embodiments, the at least one invoice comprises an electronic invoice associated with the user.

In some embodiments of the system: the module is further configured to: transmit the electronic invoice to the user; receive payment instructions from the user, wherein the payment instructions include the alias for the merchant; and applying the payment to the invoice. In other embodiments, the electronic invoice comprises data selected from the group consisting of: product identification; quantity of items ordered; price of each item; fees for services or products; tax amounts; total amount due; date payment is due; payment history; explanation of fees; explanation of services; shipping information, or combinations thereof.

In some embodiments of the system the module is further configured to: match the alias with one or more accounts associated with the merchant; and transfer a payment amount to the one or more accounts. In other embodiments, the module is further configured to: determine that the payment amount is below a maximum amount. In still other embodiments, the alias comprises an identifier selected from the group consisting of: a mobile telephone number, an email address, a social networking ID, a name, an address, a URL address, a logo, a brand, a picture, graphical art, a trade name, a trade mark, or combinations thereof.

In some embodiments, a computer program product is provided. The computer program product comprises a computer-readable medium having computer-executable instructions for performing: receiving invoice data from a merchant; identifying a user based on the invoice data, wherein the user is associated with a payment; sending information associated with the invoice data to the user and receiving payment instructions from the user, wherein the payment instructions include an alias; and determining that the merchant is a registered payment recipient based on the alias.

In some embodiments of the computer program product, the computer-executable instructions further perform: determining that the user owes the merchant a payment amount; presenting an invitation to the user to transfer a payment amount to the merchant; and communicating a payment notification to the user. In other embodiments, the computer-executable instructions further perform: determining that the merchant owes the user a payment amount; receiving payment instructions from the merchant, wherein the payment instructions include an alias associated with the user; determining that the user is a registered payment recipient based on the alias; and communicating a payment notification to the user. In still other embodiments, the computer-executable instructions further perform: receiving at least one invoice from a merchant, the at least one invoice comprising a bar code; scanning the bar code; and retrieving invoice data from the invoice based on the bar code

In some embodiments of the computer program product, the payment amount is associated with a rebate amount that is owed to the user. In other embodiments, the payment instructions comprise a payment amount, wherein the computer-executable instructions further perform: determining that the payment amount is below a maximum amount. In still other embodiments, the computer-executable instructions further perform: determining that the alias is associated with one or more account. In other embodiments, the computer-executable instructions further perform: transferring a payment amount to the one or more accounts. In other embodiments, the invoice comprises data selected from the group consisting of: product identification; quantity of items ordered; price of each item; fees for services or products; tax amounts; total amount due; date payment is due; payment history; explanation of fees; explanation of services; shipping information, or combinations thereof.

In some embodiments of the computer program product, the alias comprises an identifier selected from the group consisting of: a mobile telephone number, an email address, a social networking ID, a name, an address, a URL address, a logo, a brand, a picture, graphical art, a trade name, a trade mark, or combinations thereof. In other embodiments, the computer-executable instructions further perform: converting the invoice data into an electronic bill; sending the electronic bill to an identified user; and transferring a payment to one or more accounts associated with the merchant.

In some embodiments, a system for electronic payment and billing is provided. The system comprising: a computer apparatus including a processor and a memory; and an electronic billing software module stored in the memory, comprising executable instructions that when executed by the processor cause the processor to: receive invoice data from a merchant; identify a user based on the invoice data, wherein the user is associated with a payment; send information associated with the invoice data to the user and receive payment instructions from the user, wherein the payment instructions include an alias; and determine that the merchant is a registered payment recipient based on the alias.

In some embodiments of the system, the module is further configured to: determine that the user owes the merchant a payment amount; present an invitation to the user to transfer a payment amount to the merchant; and communicate a payment notification to the merchant. In other embodiments, the module is further configured to: determine that the merchant owes the user a payment amount; receive payment instructions from the merchant, wherein the payment instructions include an alias associated with the user; determine that the user is a registered payment recipient based on the alias; and communicate a payment notification to the user. In still other embodiments, the payment notification comprises at least a portion of the invoice data.

In some embodiments of the system, the invoice comprises data selected from the group consisting of: product identification; quantity of items ordered; price of each item; fees for services or products; tax amounts; total amount due; date payment is due; payment history; explanation of fees; explanation of services; shipping information, or combinations thereof. In other embodiments, the module is further configured to: determining that the alias is associated with a registered bank account of the merchant. In other embodiments, the alias comprises an identifier selected from the group consisting of: a mobile telephone number, an email address, a social networking ID, a name, an address, a URL address, a logo, a brand, a picture, graphical art, a trade name, a trade mark, or combinations thereof.

In some embodiments of the system, the module is further configured to: receive at least one invoice from a merchant, the at least one invoice comprising a bar code; scan the bar code; and retrieve invoice data from the invoice based on the bar code. In other embodiments, the module is further configured to: determine that the alias is associated with one or more accounts; and transfer a payment amount to the one or more accounts. In still other embodiments, the module is further configured to convert the invoice data into an electronic bill; send the electronic bill to an identified user; and transfer a payment to one or more accounts associated with the merchant.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1A is a flowchart of a system and method for invoicing and electronic billing in accordance with various embodiments of the invention.

FIG. 1B is a flowchart of a system and method for invoicing and electronic billing in accordance with various embodiments of the invention.

FIG. 1C is a flowchart of a system and method for invoicing and electronic billing in accordance with various embodiments of the invention.

FIG. 2 is a combination flowchart and block diagram of a system and method for making P2P payments in accordance with example embodiment of the invention;

FIG. 3 is a block diagram illustrating the various ways through which a customer may make P2P payments in accordance with various embodiments of the invention;

FIG. 4 provides a block diagram illustrating an online banking P2P payment system and environment in accordance with an embodiment of the invention;

FIG. 5 provides a block diagram illustrating the merchant's computing device of FIG. 4, in accordance with an embodiment of the invention;

FIG. 6 provides a block diagram illustrating the user's personal computing device of FIG. 4, in accordance with an embodiment of the invention;

FIG. 7 provides a block diagram illustrating the financial institution's online banking system of FIG. 4, in accordance with an embodiment of the invention;

FIG. 8 provides a block diagram illustrating the alias data repository of FIG. 4, in accordance with an embodiment of the invention;

FIGS. 9A-9C provide flow charts illustrating a process for invoicing and electronic billing, in accordance with embodiments of the invention;

FIGS. 10A-10H provide screenshots of a graphical user interface used during the process described in FIGS. 9A-9C, in accordance with embodiments of the invention;

FIGS. 11A-11C provide flow charts illustrating a process for receiving P2P payments, in accordance with embodiments of the invention;

FIGS. 12A-12F provide screenshots of a graphical user interface used during the process described in FIGS. 11A-11C, in accordance with an embodiment of the invention; and

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Like numbers refer to like elements throughout.

In accordance with embodiments of the invention, the terms “financial institution” or “financial entity” include any organization that processes financial transactions including, but not limited to, banks, credit unions, savings and loan associations, investment companies, stock brokerages, asset management firms, insurance companies and the like. In specific embodiments of the invention, use of the term “bank,” is limited to a financial entity in which account-bearing customers conduct financial transactions, such as account deposits, withdrawals, transfers and the like.

Embodiments of the present invention provide a system and method for online invoicing and electronic billing (eBilling). Embodiments of the invention enable merchants (e.g., small businesses) to securely and conveniently store and manage invoicing information and send or receive electronic payments. Further, embodiments of the invention allow users to make payments directly from their accounts, whether their accounts be checking, savings, line of credit, credit card, and/or other accounts, to a payment recipient (e.g., the merchant), including financial entity customers and non-financial entity customers, without having to share any confidential account information and without having to know account information for the intended payment recipient. Embodiments of the invention also allow customers and non-customers to receive payments from others directly into their financial institution accounts without requiring the customer to share account information with the payment sender. It should be noted that some embodiments of the invention allow a customer to make payments to and/or receive payments from a merchant in the same way that a customer can make payments to and/or receive payments from another person. As such, as used herein, the phrase person-to-person (P2P) is intended to include person-to-merchant (P2M), merchant-to-merchant (M2M), and merchant-to-person (M2P) unless specifically stated otherwise. Moreover, embodiments of the present invention permit a sender to send money from the sender's financial institution account directly to the recipient's financial institution account using the alias of the recipient with or without the involvement of an intermediary or a third party.

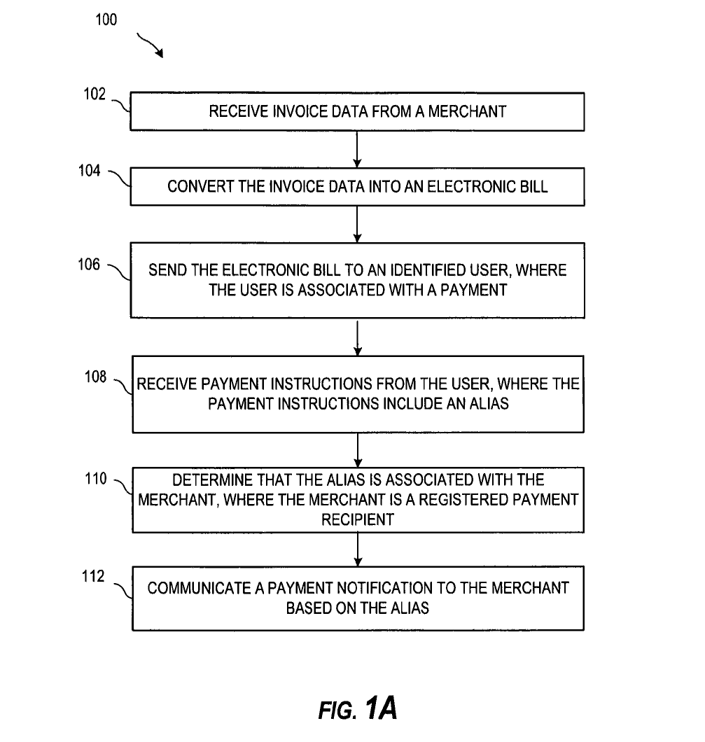

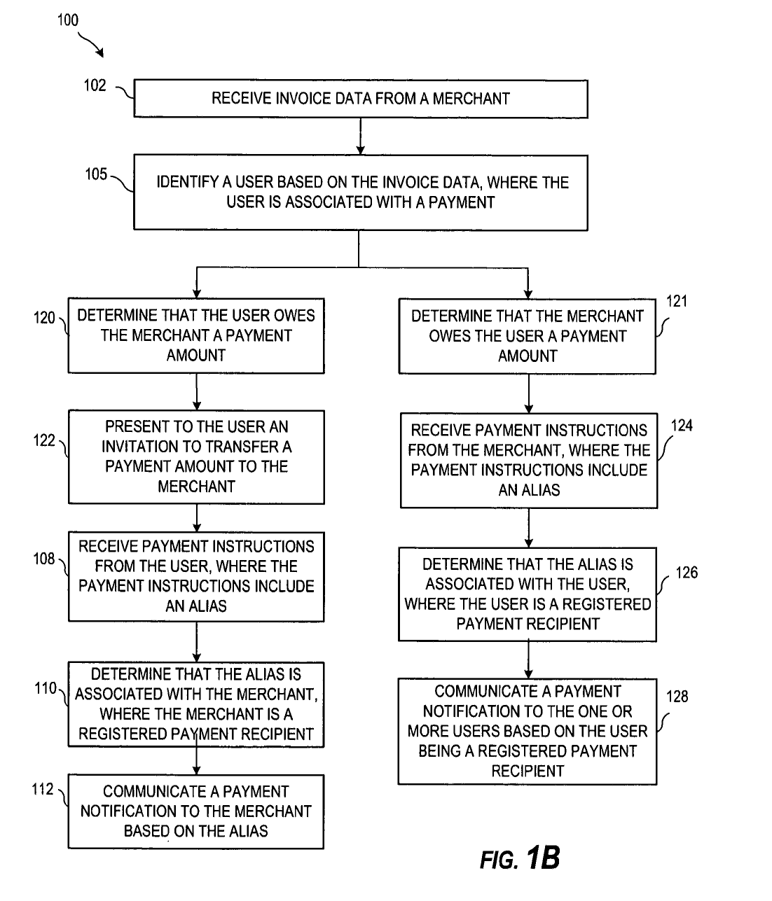

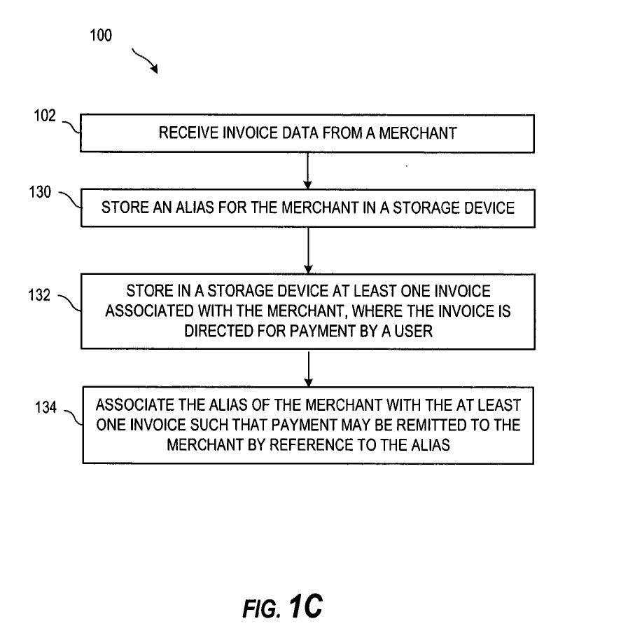

FIG. 1A is a flowchart providing an overview of a system and method 100 for invoicing and electronic billing in accordance with one or more embodiments of the invention. It will be understood that one or more devices, such as one or more mobile device and/or one or more other computing devices and/or servers, can be configured to perform one or more steps of the method 100. In some embodiments, the one or more devices performing the steps are associated with a financial institution. In other embodiments, the one or more devices performing the steps are associated with a business, third party, and/or user. For example, in some embodiments, a “node” connects several networks or financial institutions such that money can be transferred from one customer of a financial institution to another customer of a different financial institution.

In block 102 of FIG. 1A, invoice data from a merchant is received. The merchant includes a business, an individual, an agent of the merchant, an entity associated with the merchant, or any other entity. The merchant may be a customer of a particular financial institution, a non-customer of the particular financial institution, or a customer of a financial institution that is different from the particular financial institution. In some embodiments, non-customers register for an eBilling service. Examples of invoice data include the contact information of the merchant, a customer of the merchant, or vendor of the merchant, including addresses, phone numbers, websites, email, and the like; product identification and/or description; quantity of items ordered; price of each item; fees for services or products; tax amounts; total amount due; date payment is due; payment history; explanation of fees; explanation of services; shipping information, including the shipment method, carrier, “ship to” address, tracking number, etc.; legal notifications; and the like. The information is received by any method. For example, in some embodiments, a merchant inputs invoice data manually online. Other methods of receiving the invoice data include uploading invoice data to a server maintained by a financial institution, faxing a document, filling in a questionnaire, mailing the invoices, texting or emailing an attached image of the invoice, and the like.

In some embodiments, the invoice data is stored in an invoice data repository. For example, invoice data extracted from an image or a text document can be stored via a server in the invoice data repository. In some embodiments, the invoice data is presented to the merchant for editing. For example, the merchant may choose to add and/or delete users and data stored in the invoice data repository. In some embodiments, data is extracted from the invoice data. For example, an image file of the invoice is received and at least a part of the data contained therein is extracted. In still other embodiments, a bar code associated with the invoice is scanned to retrieve the invoice data. For example, a merchant may take a picture of the invoice and send the image of the invoice to a financial institution via an attachment in an email or text.

In block 104, the invoice data is converted into an electronic bill. For example, the invoice data may be re-formatted such that the information contained in a PDF file, image file, text document, or a paper invoice can be converted into electronic form and organized for processing. In block 106, the electronic bill is sent to an identified user, where the user is associated with a payment. In some embodiments, information associated with the invoice data is sent to the user. The electronic bill can be sent in any way. In some embodiments, the electronic bill is presented to the user using a mobile device via a “push” text message. In other embodiments, the electronic bill is sent to the user via an email. In still other embodiments, the user accesses the electronic bill using a financial institution's online banking system (e.g., the financial institution's online banking system 700).

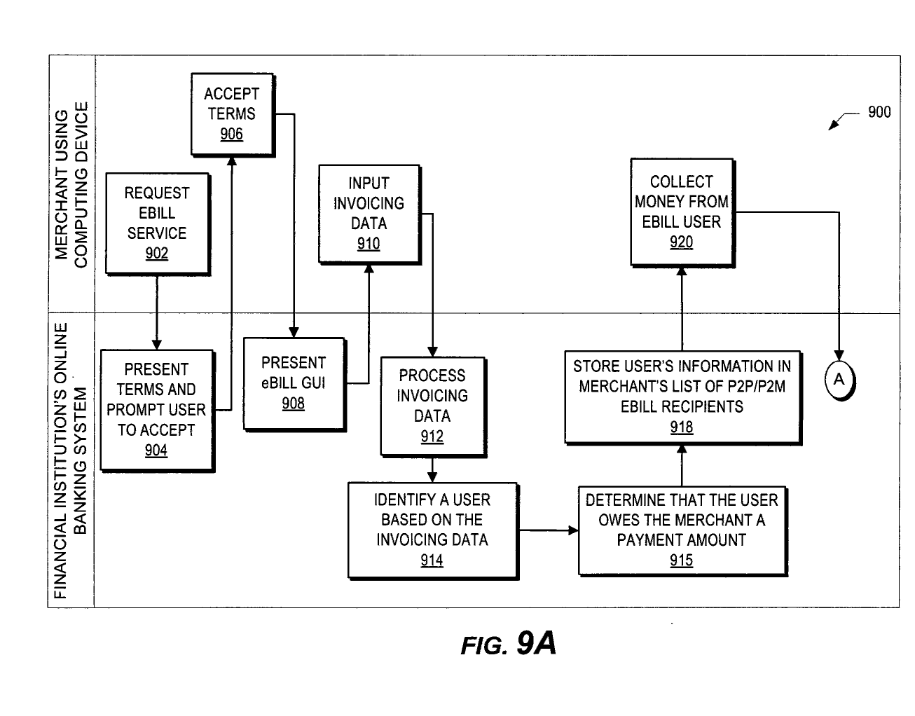

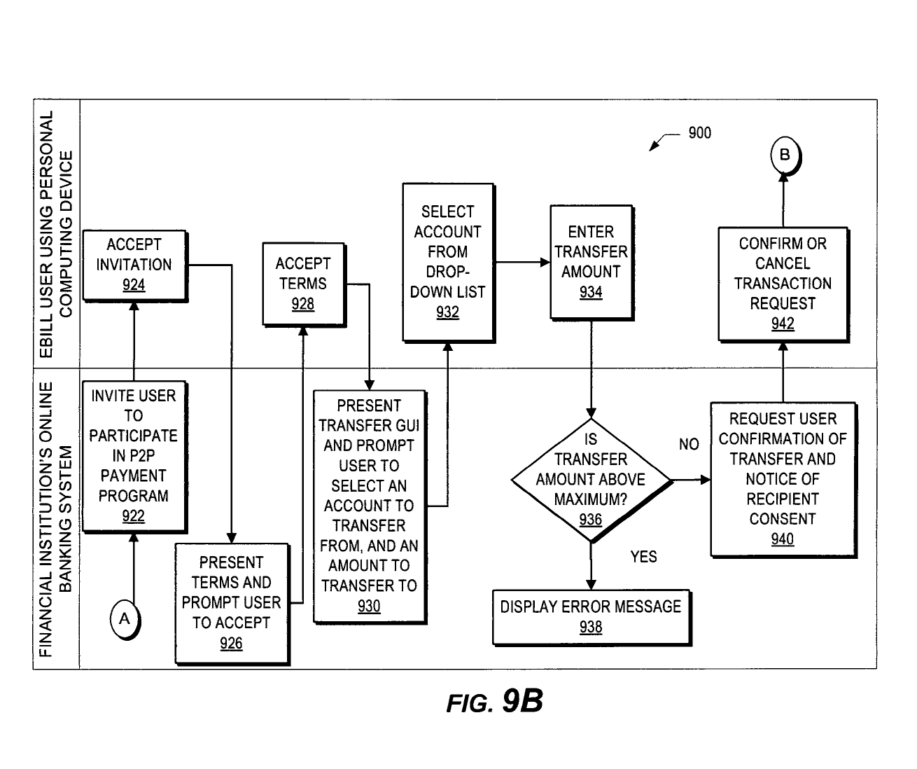

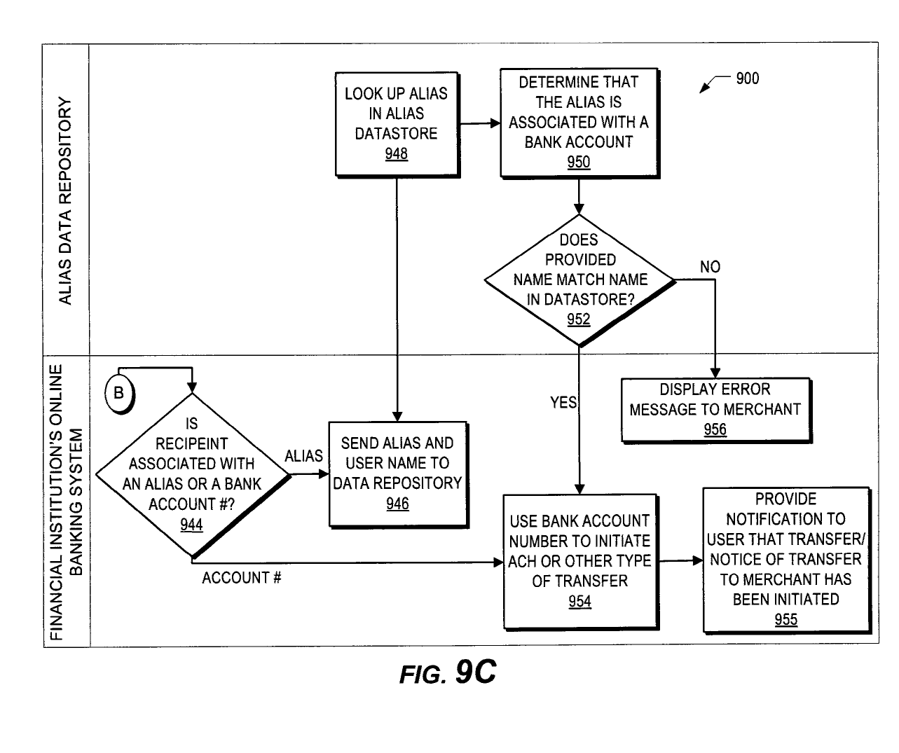

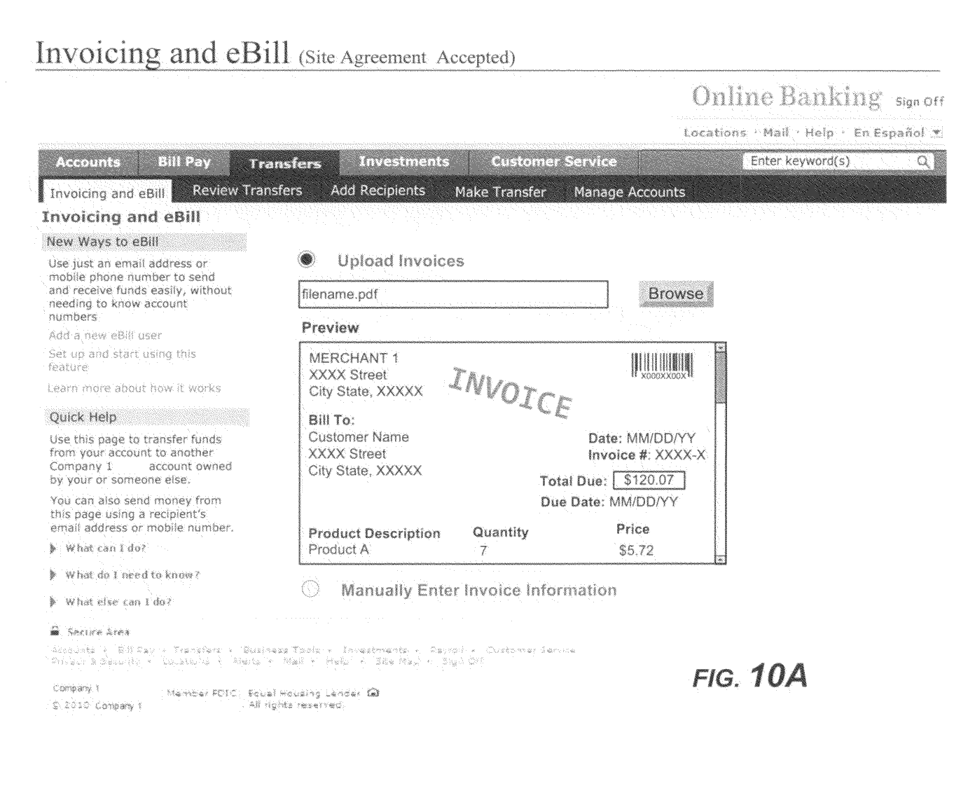

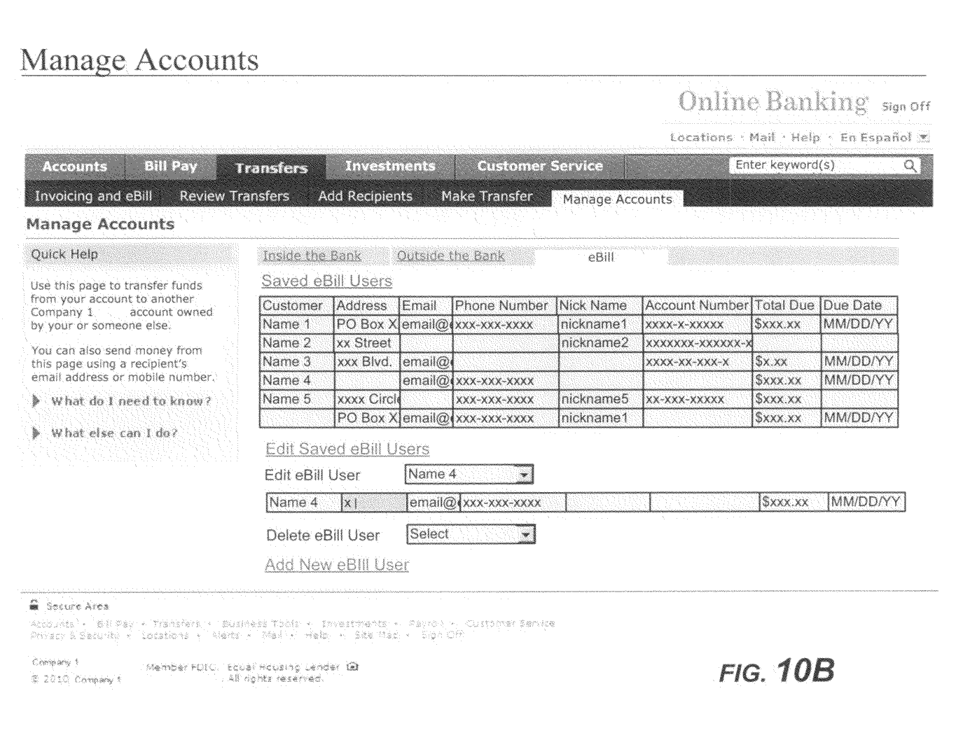

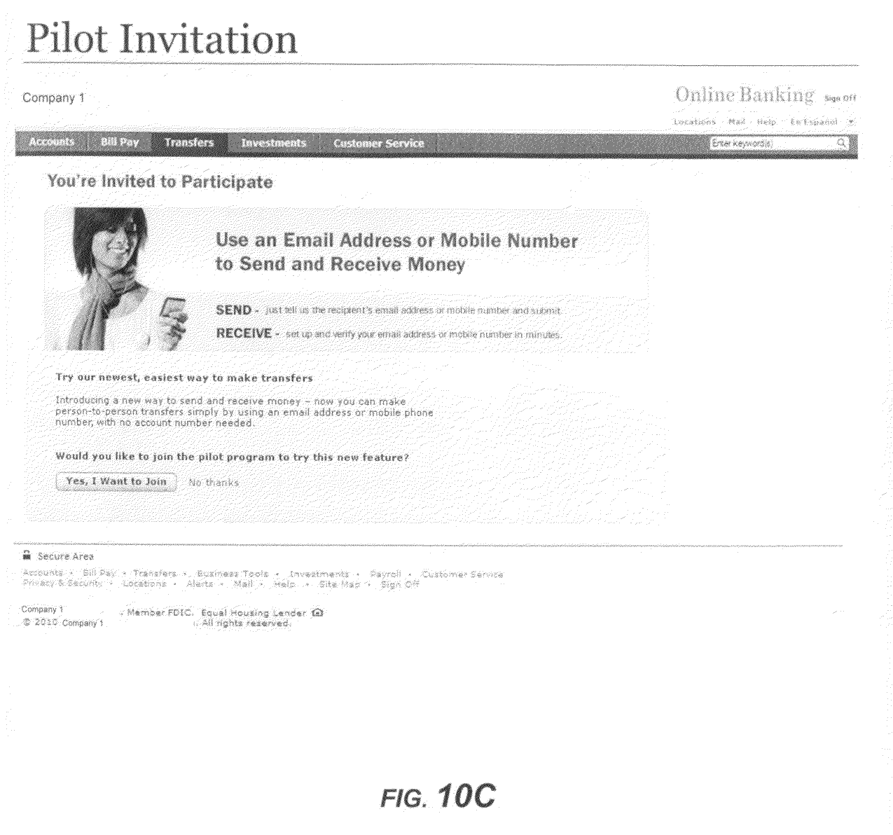

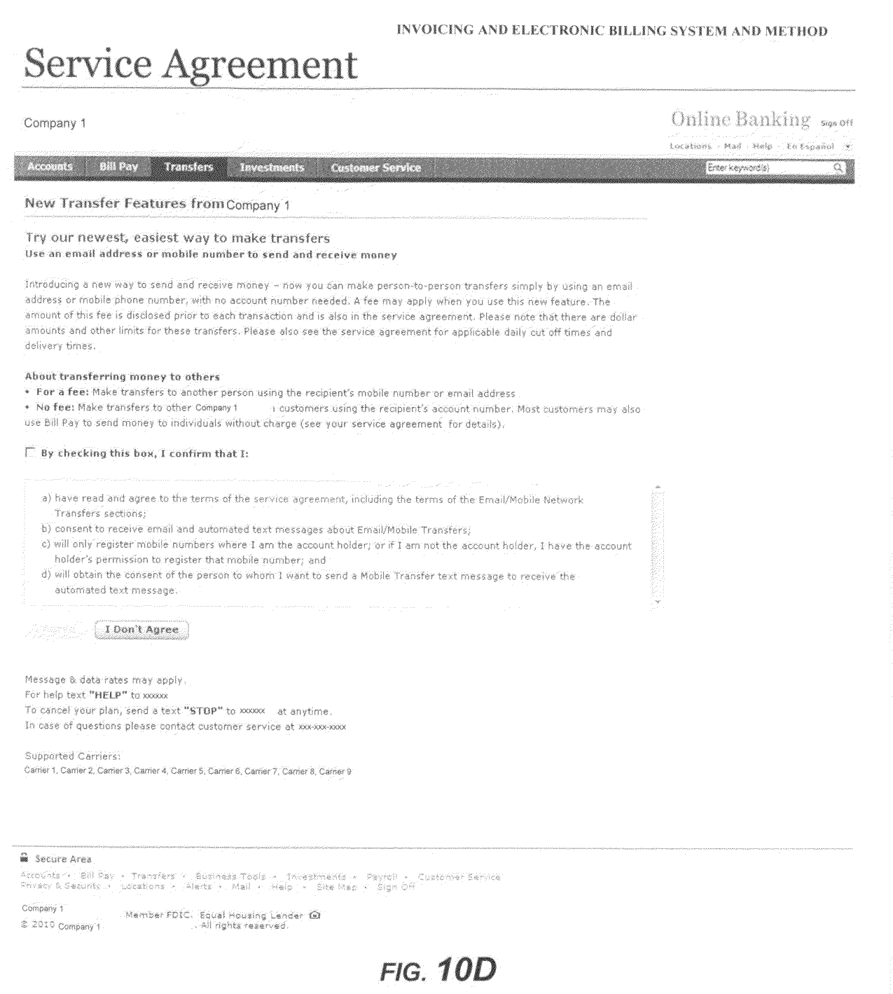

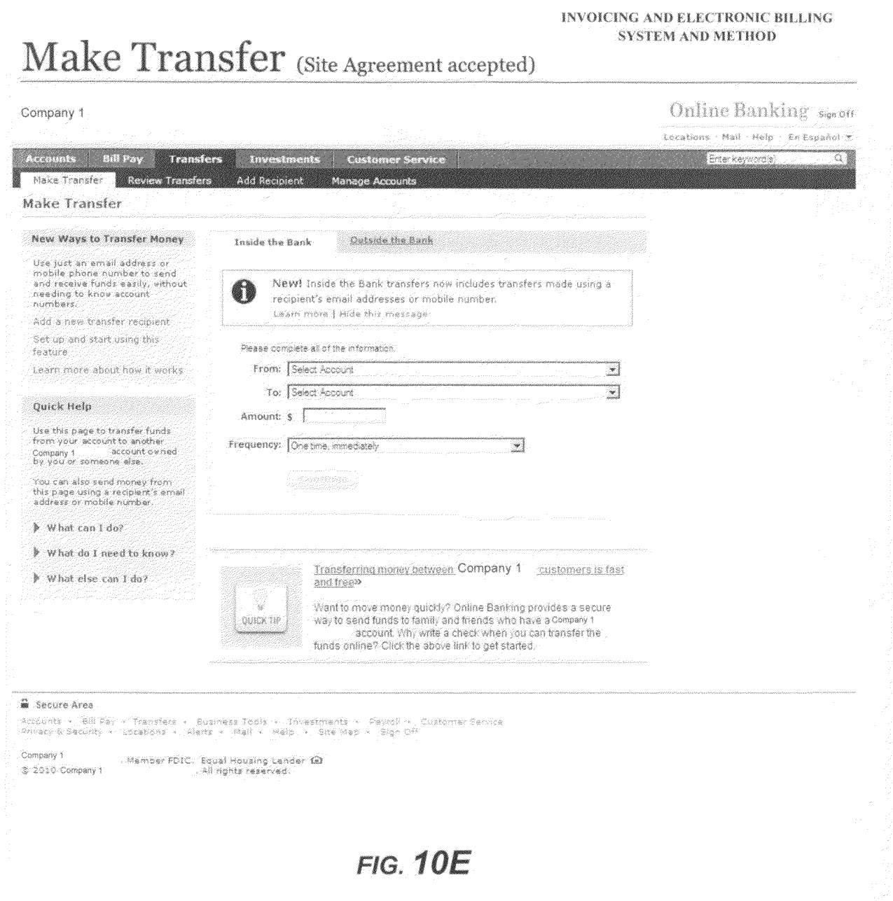

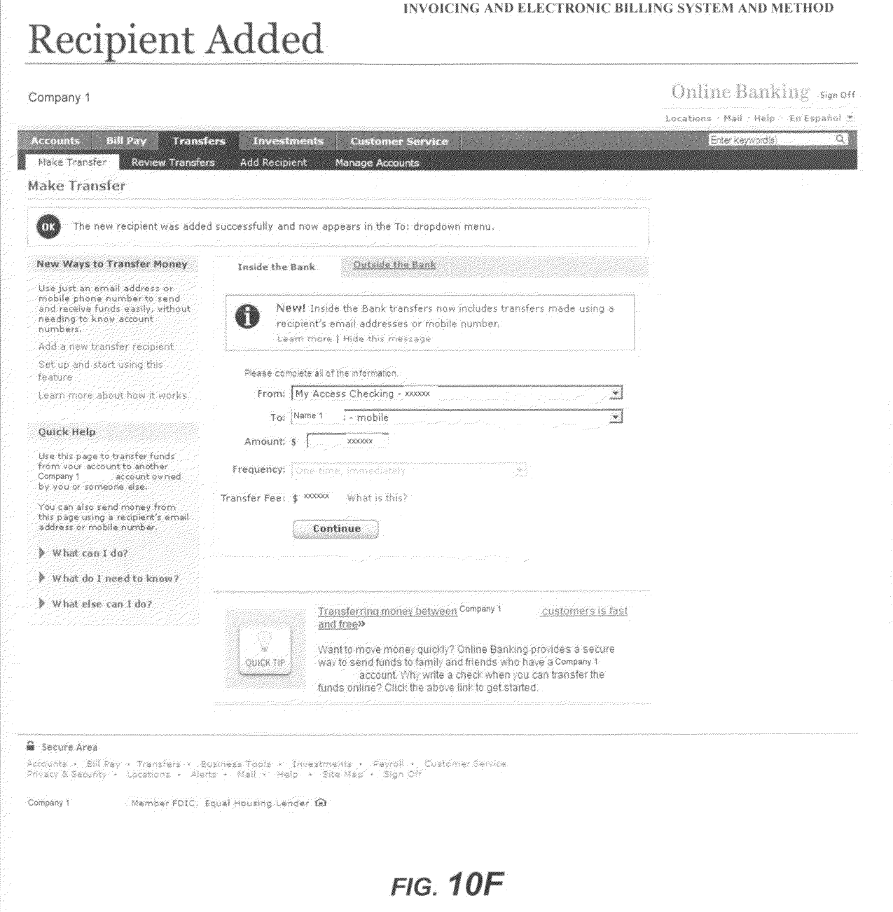

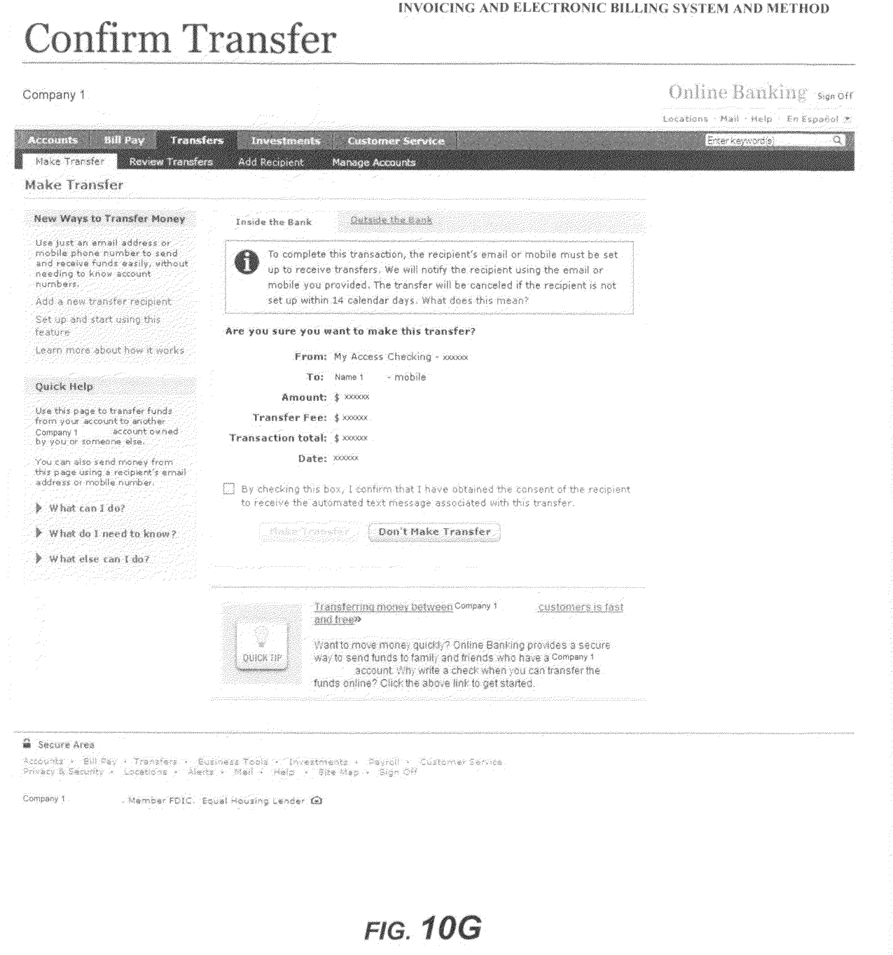

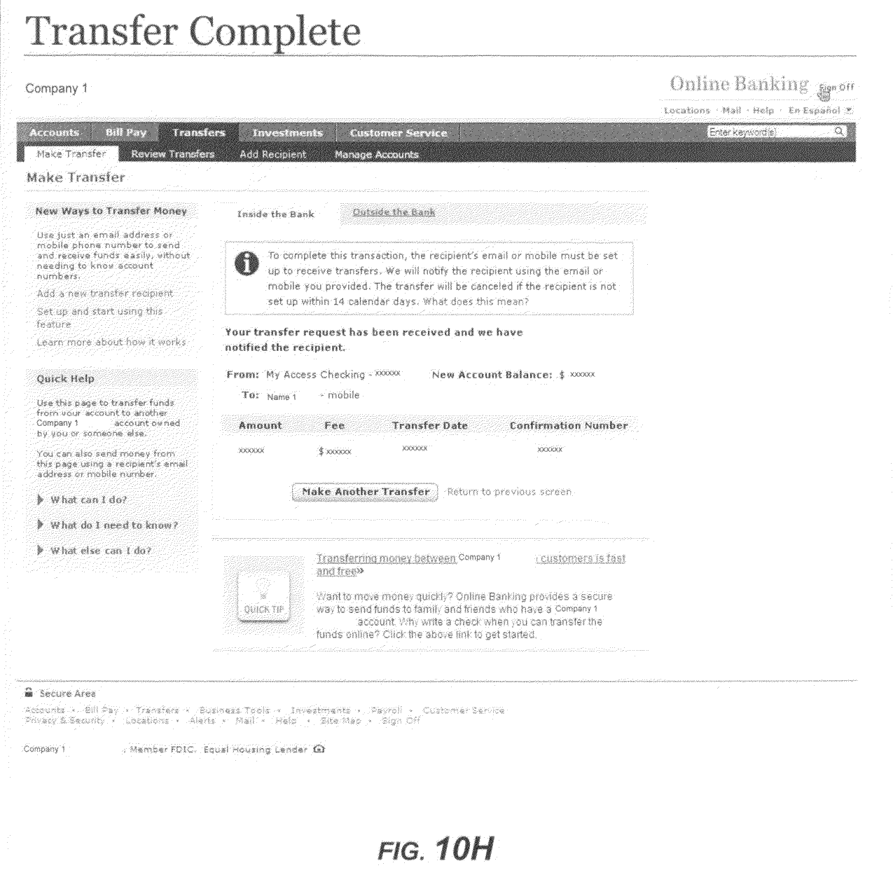

In block 108, payment instructions from the user are received, where the payment instructions include an alias as described in more detail below with regard to FIGS. 9A-10H. The alias may be any unique identifier other than the user's financial institution account number. Typically, the alias is an identifier that friends, family, and/or other members of the public uniquely associate with the user or any entity transferring or receiving a payment. For example, the alias may be a mobile telephone number, an email address, a social networking ID, a name, an address, a URL address, a logo, a brand, a picture, graphical art, a trade name, a trade mark, and/or any other textual, graphical, or visual indicator. The embodiments of the invention described herein in the other figures generally permit the user to use either a mobile telephone number or an email address as the account alias, but it will be appreciated that, in view of this disclosure, other embodiments of the invention may allow use of other types of aliases. In some embodiments, the payment instructions further includes a payment amount. For example, the user can pay part of the amount due or the entire amount due on the invoice. In other embodiments, the payment instructions include a payment account. The user, in some embodiments, can choose to pay at least a portion of the payment amount from one or more payment accounts. For example, the user may set up an automatic monthly payment schedule where half of the payment is drawn from a checking account and half of the payment is drawn from a joint checking account.

In block 110, it is determined that the alias is associated with the merchant. In some embodiments, an online banking system searches an alias data repository (e.g., the alias data repository 800) to match the alias with an account associated with the merchant. In some embodiments, the merchant registers an alias. For example, when a merchant registers for the invoicing and electronic billing service (see, FIG. 9A), the merchant may also register an alias or may be automatically assigned an alias based on the information necessary for registration, and the alias can be stored in an alias data repository for later confirmation. In block 112, a payment notification is communicated to the merchant based on the alias as described in more detail below with regard to FIGS. 9A-10H. The merchant, for example, may use the payment notifications as a bookkeeping method to track invoices that have been paid or unpaid, payment amounts that are beyond the payment due data, the amount paid, and the like

Referring now to FIG. 1B, embodiments of the method 100 are further illustrated. In block 102, invoice data from a merchant is received as described above with regard to FIG. 1A. In block 105, a user is determined based on the invoice data, where the user is associated with a payment. The user includes a customer, vendor, debtor, creditor, joint venture, and/or partner of the merchant, or any other entity associated with the merchant. In block 120, it is determined that the user owes the merchant a payment amount. For example, an invoice addressed to the user (i.e., the “bill to” recipient) showing a positive total amount due can indicate that the user owes the merchant a payment amount. The user name or alias may be associated with a total due amount to determine that a payment amount is due to the merchant. In block 121, it is determined that the merchant owes a payment amount to the user. For example, the merchant may owe a customer a rebate or reimbursement, or may owe a payment amount to a vendor for services or goods. The user name and alias may be associated with a negative amount due or the “bill to” recipient may be associated with the merchant to determine that the merchant owes a payment amount to the user.

In block 122, an invitation to transfer a payment amount to the merchant is presented to the user. In some embodiments, the user is presented with a transfer GUI as described in more detail below with regard to FIG. 9A-10H. In some embodiments, the invitation comprises the electronic bill. In block 108, payment instructions from the user are received, where the payment instructions include an alias. In some embodiments, the payment instructions include a payment amount. In other embodiments, the payment amount is less than the payment amount owed to the merchant. For example, the payment amount may be a minimum required by the merchant to be paid by the due date. In still other embodiments, the payment amount comprises the owed payment amount. In yet another embodiment, the payment amount is more that the amount owed to the merchant. In some embodiments, the payment instructions include a payment explanation. For example, the user may choose to pay at least a part of an upcoming bill or another bill and may include notification of this payment in the payment instructions. The payment explanation, in some embodiments, is included in the payment notification of block 112.

Referring again to FIG. 1B, in block 110 it is determined that the alias is associated with the merchant, and in block 112, a payment notification is communicated to the merchant based on the alias, all of which are described above with regard to FIG. 1A.

In block 124 of FIG. 1B, payment instructions from the merchant are received, where the payment instructions include an alias. In some embodiments, the payment instructions include a payment amount and/or payment account. For example, the merchant may choose to register one or more account for receiving payments and one or more accounts for transferring payments. The merchant may, for example, choose a specific account for transferring money based on the user or the amount of money transferred. In other embodiments, one or more users are separated into groups. For example, the merchant may choose to group certain users with a particular account based on the business unit associated with the products or services purchased by the user. In this way, funds are directed to the proper business unit.

In block 126, it is determined that the alias is associated with the user, where the user is a registered payment recipient, in block 122, a payment notification is communicated to the user based on the user being a registered payment recipient, and in block 128, a payment notification is communicated to the user based on the user being a registered payment recipient. The contents of blocks 126-128 are described in greater detail with regard to FIGS. 9A-12F. In some embodiments, the payment notification includes a reward offer. For example, the payment notification may include a rebate amount and another rebate offer or a coupon. In other embodiments, the payment notification comprises at least some of the invoice data. For example, the payment notification may include the payment due date, a product identification of the products ordered, explanation of fees, taxes, quantity of products ordered, and the like.

Referring now to FIG. 1C, an embodiment of the method 100 is further illustrated. In block 102, invoice data from a merchant is received as described above with regard to FIG. 1A. In block 130, an alias for the merchant is stored in a storage device. In some embodiments, the alias is stored in alias data repository (e.g., the alias data repository 800). In some embodiments, the alias is based on the invoice data. For example, the logo, name, or phone number of the merchant contained in an uploaded invoice may be extracted from the invoice to generate the alias. The merchant may, for example, input the alias using a financial institution's online banking system.

In block 132, at least one invoice associated with the merchant is stored in the storage device, where the invoice is directed for payment by a user. In some embodiments, the at least one invoice is stored in an invoice data repository. The invoice data repository, in some embodiments, includes a list of saved users (see, e.g., FIG. 10B). The list of saved users includes invoice data associated with the users. For example, the list may include the name, alias (e.g., mobile phone number and email address), account number of the user, and any other information associated with the user. In some embodiments, a search term submitted by the merchant is matched with a user. For example, if a merchant searches for “user 1” in the invoice data repository, twelve different users associated with the term “user 1” may be produced in the search results based on the invoice data. The merchant can then choose the user from the search results based on, for example, a phone number that corresponds with the correct user.

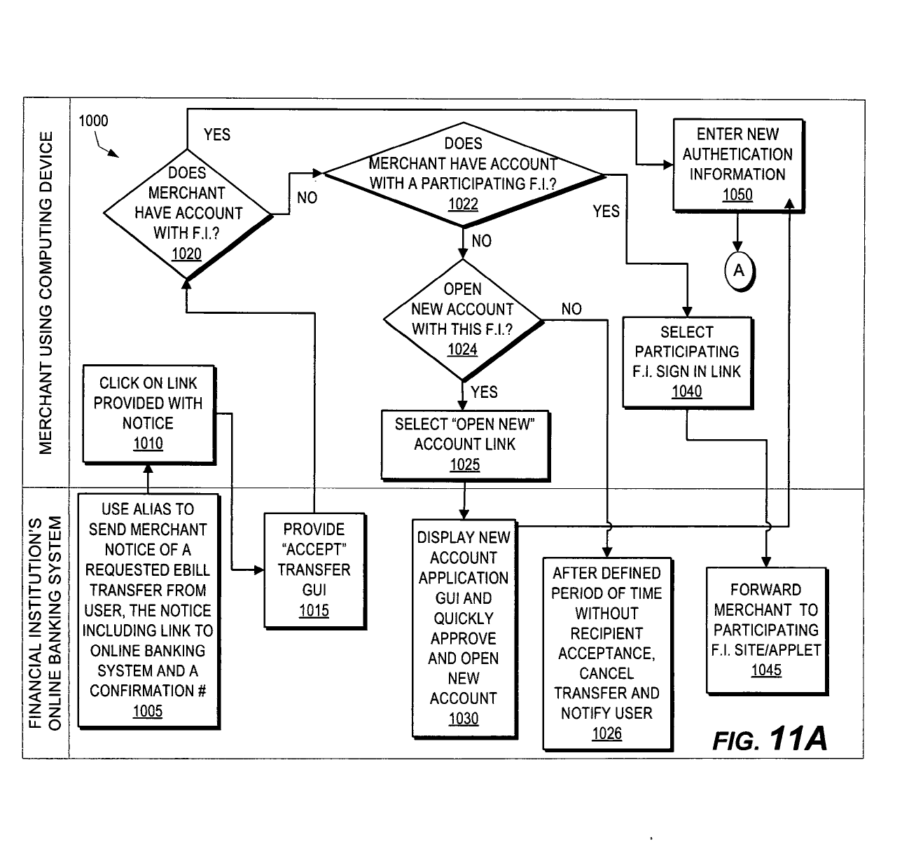

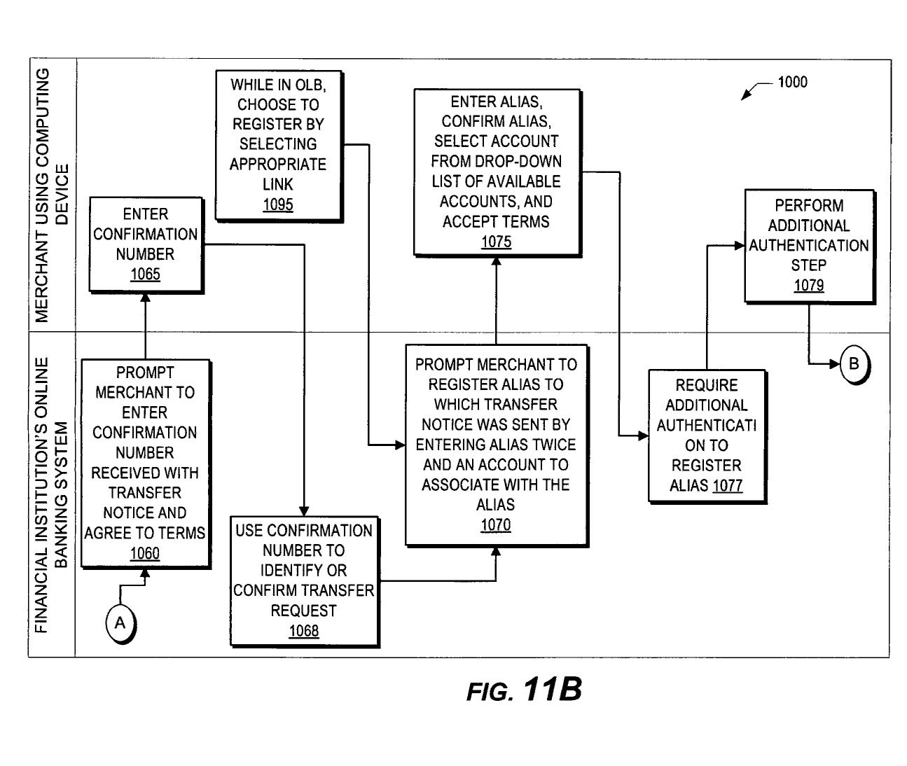

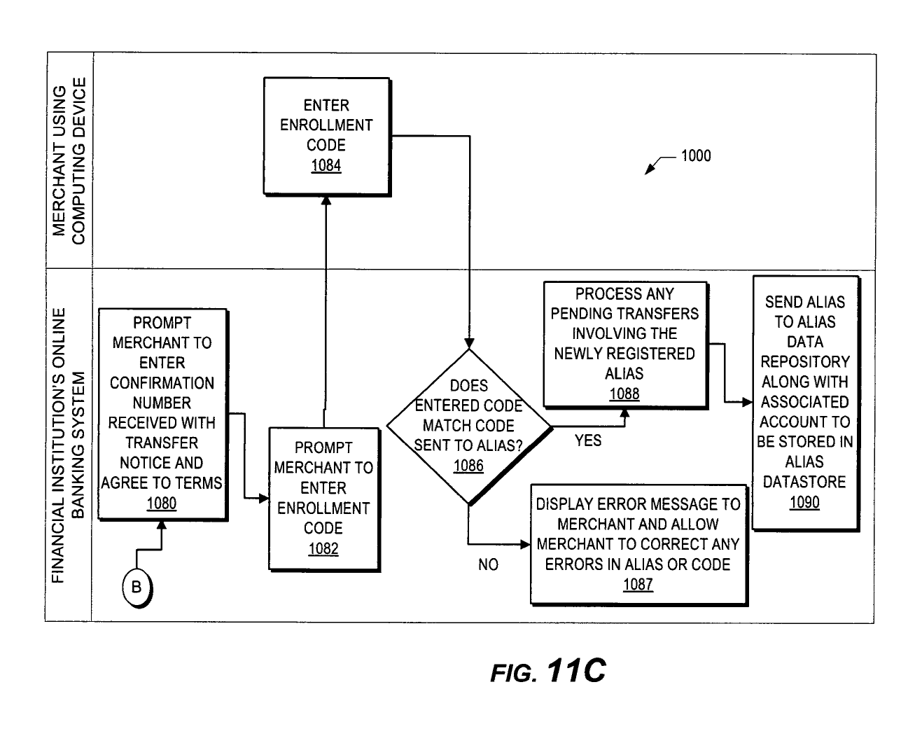

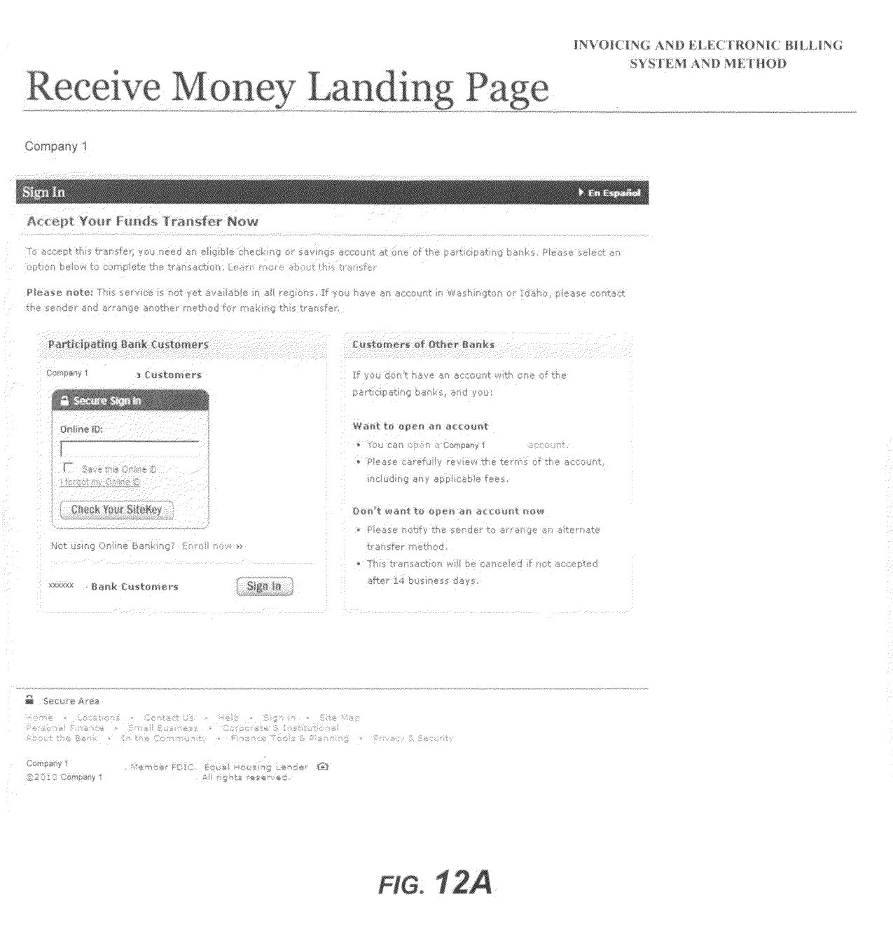

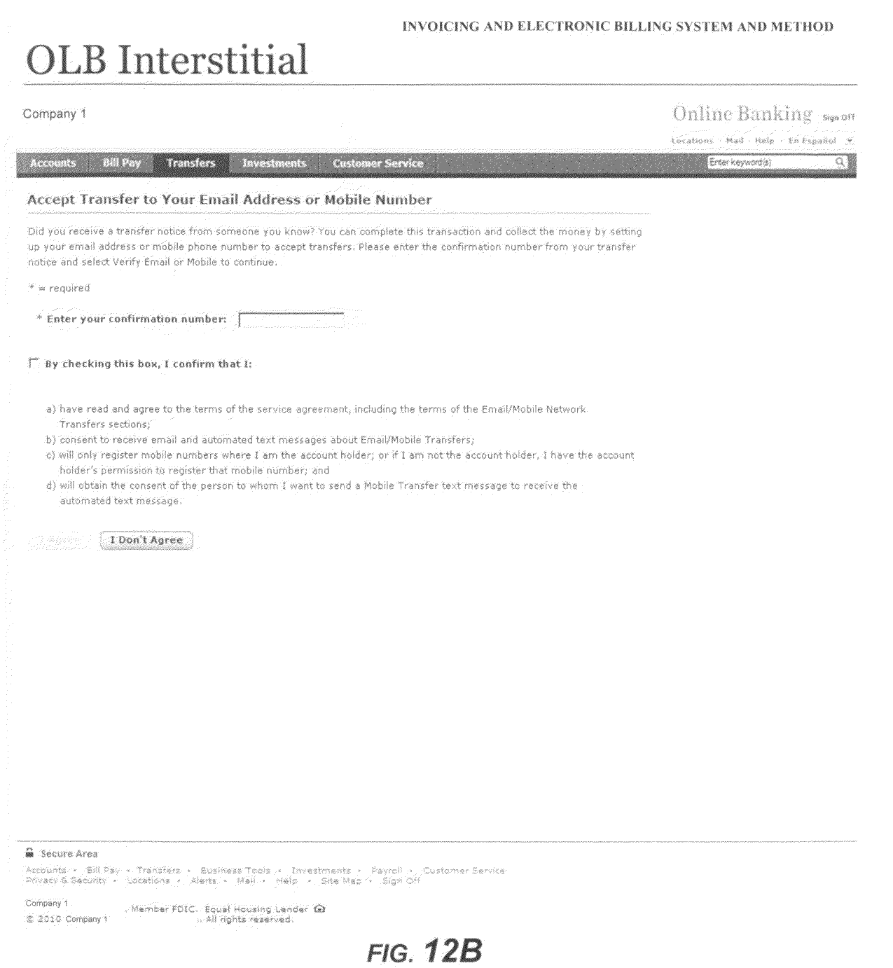

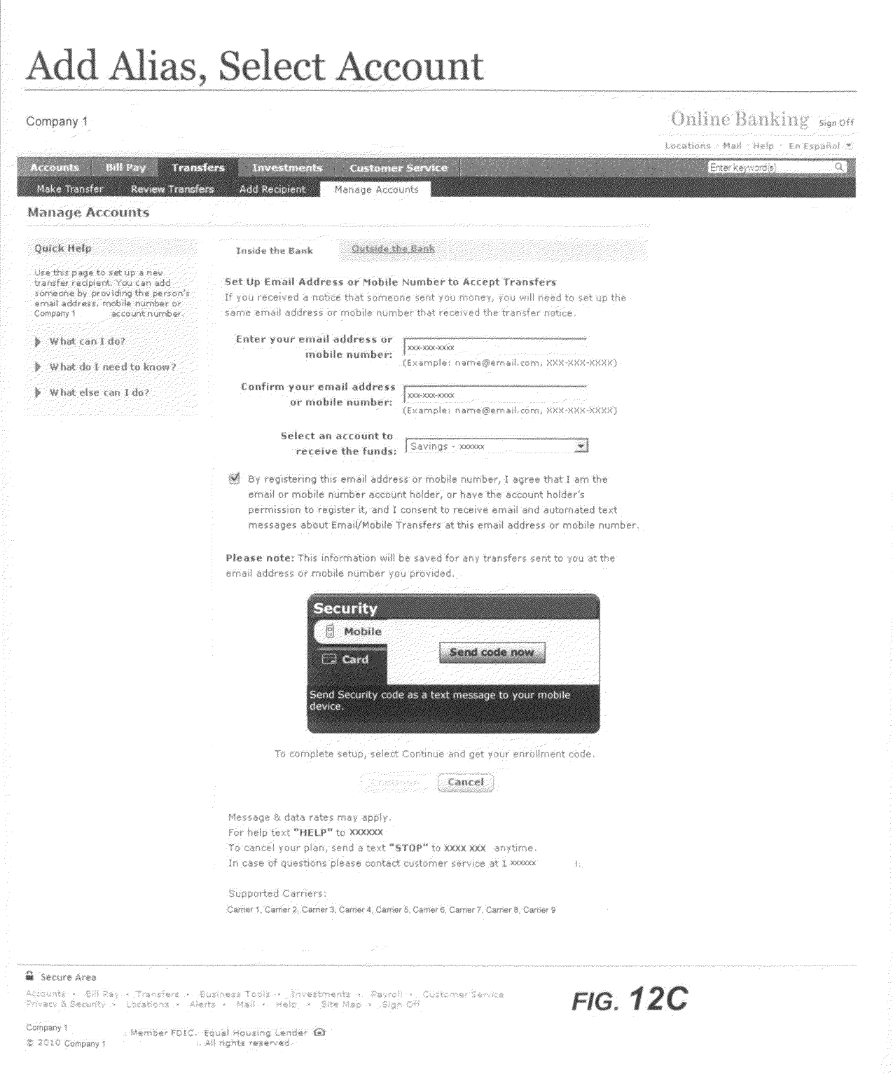

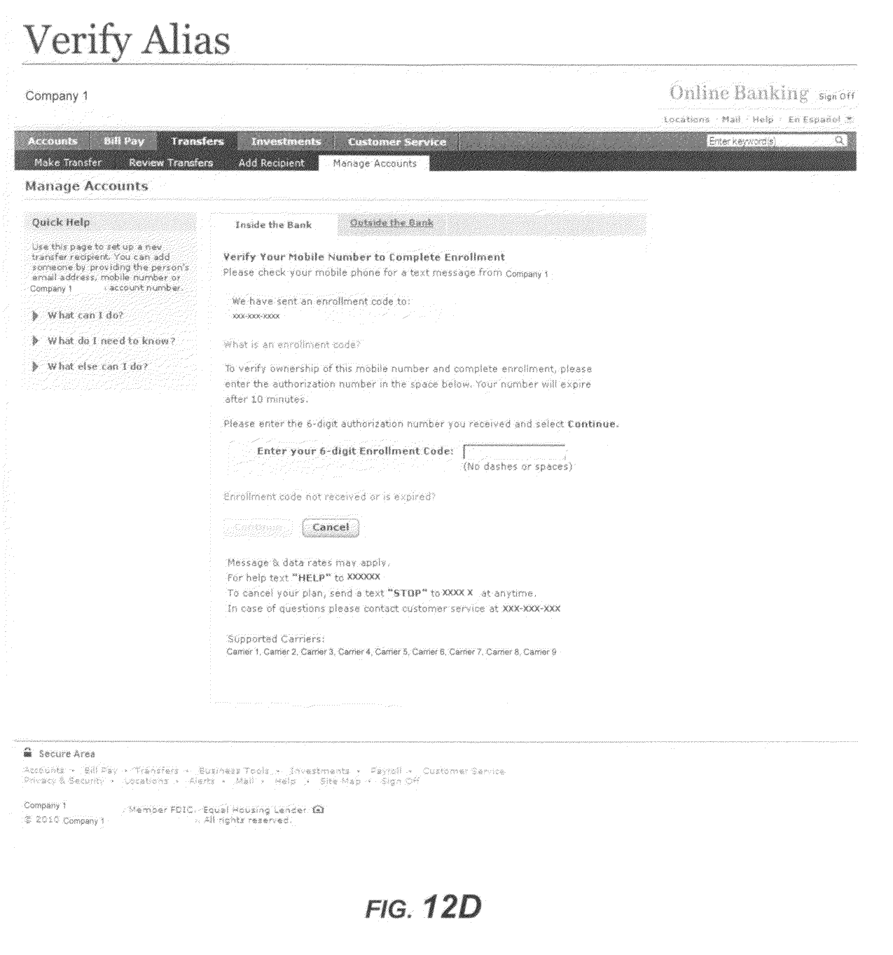

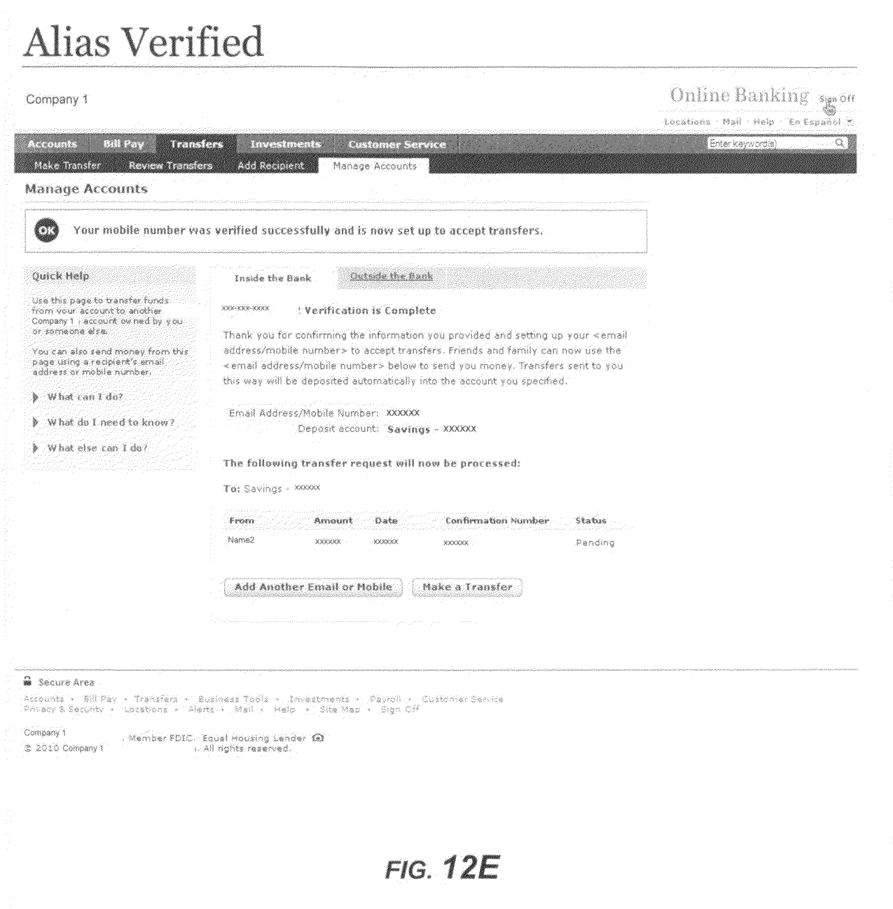

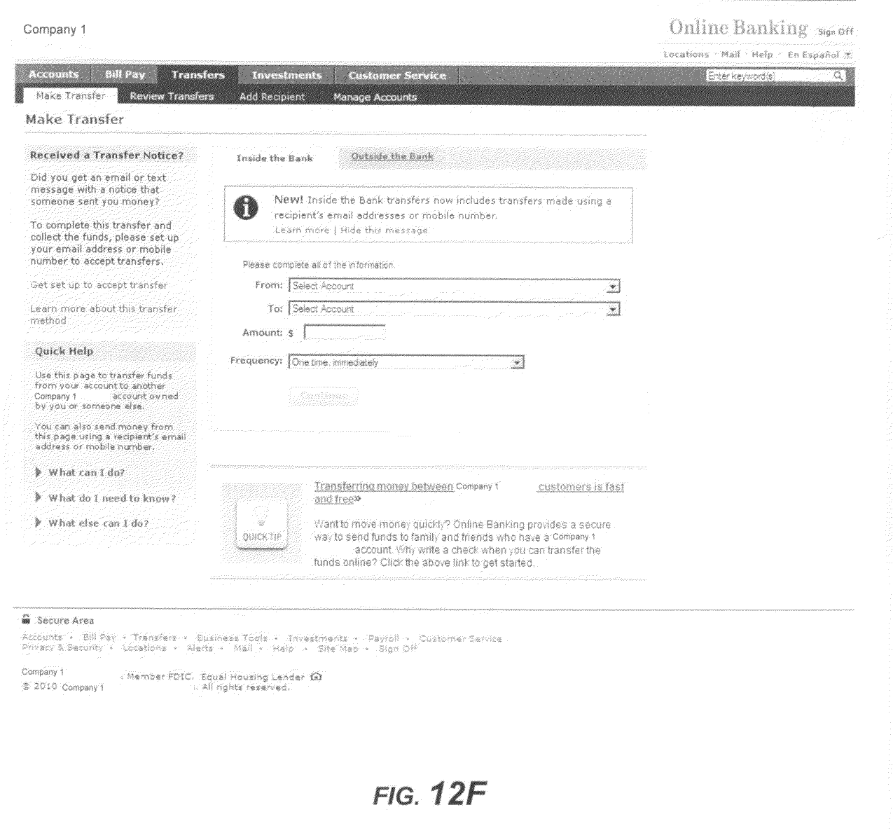

In block 134, the alias of the merchant is associated with the at least one invoice such that the payment may be remitted to the merchant by reference to the alias. In some embodiments, information associated with the invoice is transmitted to the user. For example, the user may be presented with an invitation to transfer a payment amount to the merchant via a mobile device or personal computing device as described with regard to FIG. 1B. In some embodiments, payment instructions are received from the user, where the payment instructions include the alias of the merchant. In other embodiments, a determination is made that the merchant is a registered payment recipient based on the alias. And in still other embodiments, payment to the invoice is applied. For example, in some embodiments, the merchant affirms a transfer request from the user as described in FIGS. 11A-12F.

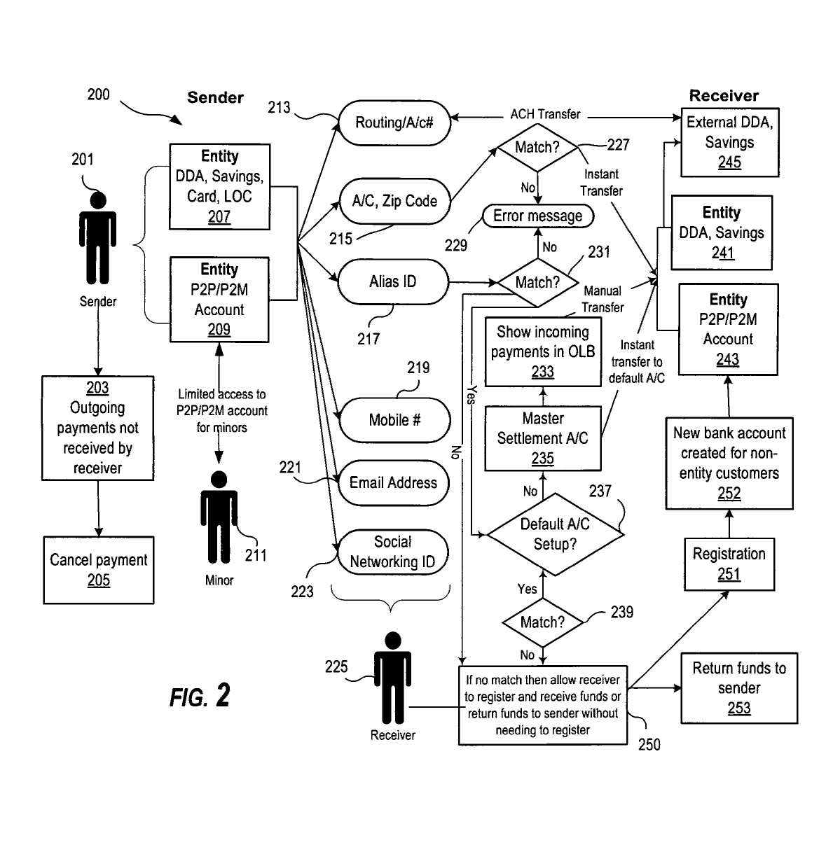

FIG. 2 is a combination block diagram and flowchart providing an overview of a system and method 200 for making P2P payments, in accordance with one or more embodiments of the invention. A sender 201 with an eligible account 207, e.g., checking (demand deposit account or “DDA”), savings, money market, line of credit, credit card, etc., of a financial entity registers and makes use of this service. The sender includes a user, a merchant, customers of financial institution, non-customers of a financial institution, or any other individual or entity associated with an eligible account. During the registration process, the sender 201 is able to set up an alias identifier (ID) 217 (or simply an “alias”) that maps back to the customer's account.

The information provided by the sender 201 during registration of an alias may be verified to confirm that the sender 201 does have access to a mobile number 219, email address 221, social networking ID 223, or other alias 217 provided. For example, as described in greater detail below, the financial institution (or other entity that maintains a database of aliases and associates them with financial institution accounts) may send a communication to the sender 201 using the alias and require the sender 201 confirm access to the alias by responding to the notice in some way. For example, if the alias registered by the sender 201 is the mobile telephone number 219, the financial institution may send a text message to the mobile telephone number 219 with a code and then require that the sender 201 enter the code into a mobile banking or online banking application to confirm that the mobile telephone number is associated with the sender 201. Once the alias information is verified, then the alias is linked to one or more of the sender's financial institution accounts in a data repository maintained by the financial institution or some other entity that provides an alias registry service to the financial institution.

The sender 201 can also use embodiments of the invention to make payments to other entity's, such as receiver 225, using an alias of the receiver 225. In some embodiments of the invention, the sender 201 is able to set preferences for accounts to be used for outgoing payments, and default account(s) for incoming payments. In some embodiments of the invention, the financial institution places limits (e.g., maximums and/or minimums) on how much money can be sent or received over a specified period of time using P2P payment aliases, and such limits may be based on the sender, the receiver, whether the receiver is a sender of the financial institution or a partner financial institution, account history, credit ratings, sender status, whether the sender has registered the alias, and/or any other relevant information. In some embodiments, the sender 201 can also establish limits on P2P payments. For example, a sender 201 may want to set a maximum of $1000 for P2P payments where an alias is used for the recipient as opposed to an account number.

In some embodiments of the invention, the sender 201 may also have an option of opening a new P2P account 209 with the financial institution that the sender may use exclusively for making and/or receiving P2P payments. This financial entity P2P account 209 may be like any other account hosted at the financial entity and so money may be moved instantly into this account 209 through the regular online banking transfer process for moving money between a sender's accounts. This account 209 may be a type of checking account except that it may come with certain limitations, e.g., no checks, maximum balance limits, number of daily transactions or the like, and may be opened by senders by providing much less information as compared to a regular checking account. The financial entity may, at a minimum, require senders to provide certain information, such as name, address, date of birth, and social security number, in order to comply with Anti-Money Laundering (AML) regulations. Senders 201 of the financial entity may also have an option to set up P2P accounts 209 (i.e., sub-accounts) for minors 211, other dependents, or related entities. Senders 201 are able to access these accounts just like any of their other accounts. In addition, senders 201 are able to set up an online banking access ID for the minor 211 that the minor 211 may use to sign into online banking but have access only to the specific minor P2P account 209 set up for them. These P2P-specific accounts and sub-accounts are described in more detail in U.S. patent application Ser. No. 12/038,177 filed on Feb. 27, 2008 and entitled “Sub-Account Mechanism,” which application was assigned to, or subject to an obligation to assign to, the same assignee of the present application at the time of filing of the present application and at the time of conception of the inventions described herein.

Referring again to FIG. 2, senders 201 of the financial entity are able to make payments to other people through any of a number of different methods. Payments may be made by a routing number/account number 213. Payments may be transferred directly to an external DDA or saving account 245. Payments may also be made by providing an account number and an additional identifier, such as a zip code 215. If there is a match 227 to an existing financial entity account, then the funds are transferred instantly to that account. Else, an error message 229 may be generated.

In accordance with embodiments of the invention, payments may be made by providing an alias 217. In general, as described in greater detail below, the sender 201 initiates a P2P payment using an alias by communicating an alias 217 and an associated payment amount to the financial institution. The financial institution then accesses an alias database, or other type of data repository, to determine if the entered alias 217 has been registered by the alias holder and is, thereby, associated with a particular financial institution account. If the alias 217 does have a match 231 to another sender in or financial institution account of another sender, then the payment may be initiated to that person, as described in greater detail below. If there is no match, then either the error message 229 is generated or, if possible, the alias 217 may be used to contact the intended recipient and allow this person to register the alias 217 and thereby associate the alias with a financial institution account. At any time, if outgoing payments or payment notifications are not received by a receiver (as represented by block 203), the payment may be canceled (as represented by block 205).

In some embodiments of the invention, an alias 217 may be associated with multiple financial institution accounts of the alias holder. In some such embodiments, the alias holder may be a able to establish a default account when registering the alias 217 or afterwards. Consequently, if a receiver 225 does have a default account for incoming payments in 237, then the funds may be transferred instantly to that account(s). If the receiver 225 has not set up a default account in 237 but the receiver 225 does have multiple accounts associated with the alias 217, then the funds may be moved to a master settlement account 235 and the receiver 225 may see the payment as an incoming payment within online banking 233. The receiver 225 may then be able to use the online banking application to move the funds instantly to any of the receiver's others accounts. In other embodiments, however, each alias 217 is associated only with one financial institution account and, therefore, steps 237 and 235 are not needed and the payment is deposited directly into the one financial institution account associated with the alias 217.

As further illustrated in FIG. 2, the alias 217 may be a mobile telephone number 219 and, as such, payment may be made by the sender 201 providing a mobile phone number 219 (the mobile telephone number 219 being the mobile telephone number of the intended payment recipient 225) along with an associated payment amount. This operation may perform exactly as described above for the alias 217 if there is a match in 239 on the mobile number. If there is no match in 239, then a text message may be sent to the mobile number 219 provided (as represented by block 250). If the receiver 225 of the message is an existing financial institution customer (or, in some embodiments, if the receiver 225 is a customer of a partner financial institution), then that person may be allowed to sign into their online or mobile banking account, register the phone number as illustrated by block 251 (thereby associating the phone number with a financial institution account for P2P payment purposes), and then receive funds similar to the process described above for the alias 217. If the receiver 225 is not a financial entity customer with an account eligible for receiving funds, then the receiver 225 may be given the option to sign up (as represented by block 252) for a financial institution account 241 or 243 at the financial institution or return funds to the sender (as represented by block 253). In some embodiments, the funds in the accounts 241 and 243 are transferred to an external account 245.

As further illustrated in FIG. 2, the alias 217 may be the email address 221 and, as such, payment may be made by the sender 201 providing an email address 221 (the email address 221 being an email address of the intended payment recipient 225) along with an associated payment amount. This operation may perform exactly as described above for a mobile number 219 except that the notification message (with the registration or account opening option if appropriate) is sent to the email address 221 provided.

In some embodiments of the invention, payment may be made by providing a social networking ID 223, such as a unique ID associated with the receiver 225 on a particular social networking Internet site. In such a situation, the process operates in the same way as described above for mobile phone number 219 and email address 221 except the social networking platform may be used to notify the receiver based on the social networking ID 223 provided.

In all cases described above, if the receiver 225 is already a customer of the financial institution or a partner financial institution and has already registered the alias 217 provided by the sender 201, a text message, email, online banking notice, mobile banking notice, or other type of message may be sent to receiver 225 based on the alias 217 entered by the sender 201 or irrespective of information entered by sender if there is other contact information found in the receiver's profile, the notification notifying the receiver 225 of the payment. In some embodiments, the receiver 225 may be allowed to reject or re-route the payment. In some embodiments of the invention, the sender 201 is permitted to include a note to the recipient 225 along with the payment, such as a note explaining to the recipient what the purpose of payment.

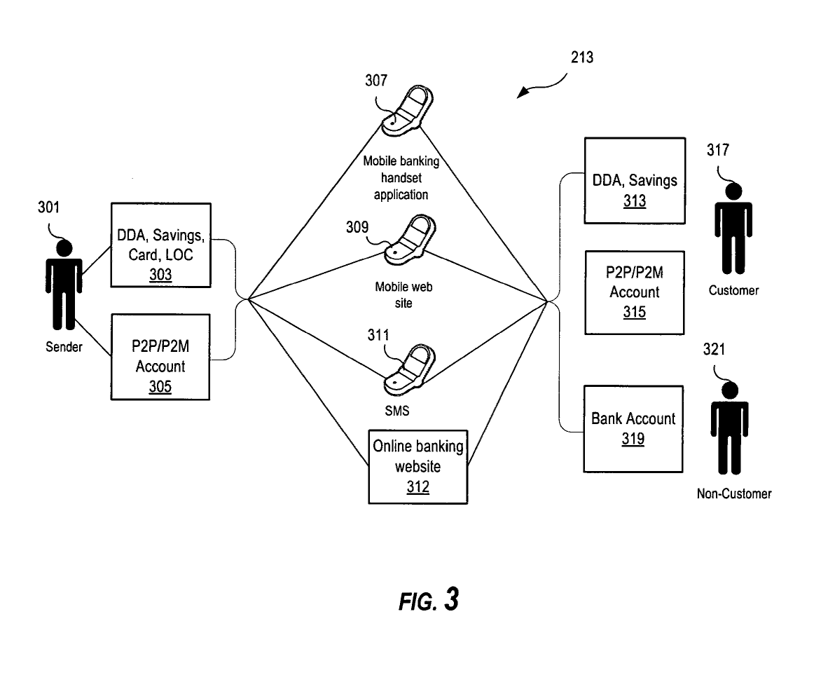

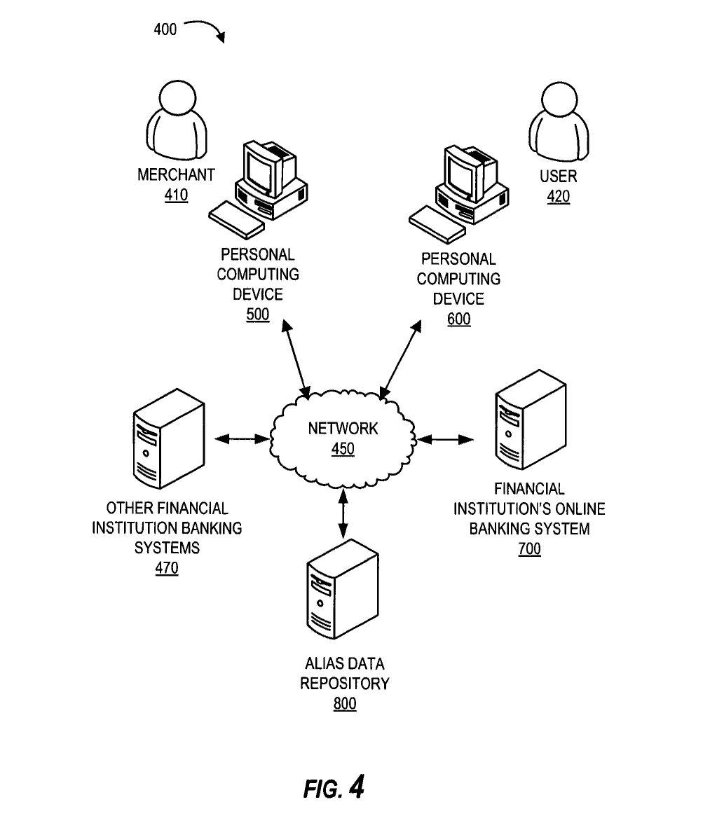

FIG. 3 is a block diagram illustrating the various ways through which a sender may make P2P payments in accordance with various embodiments of the invention. As illustrated, in some embodiments of the invention, a sender 301 who is signed up for the P2P payment service has the option to initiate P2P payments from a DDA, savings, line of credit, and/or credit card account 303 of the financial entity (and/or from a P2P-specific account 305 with the financial entity) through the financial entity's mobile banking website 309 or a mobile banking handset application 307 by providing any of the above-described alias information, e.g., phone number, email address, social networking ID, and/or other alias, along with a payment amount. In some embodiments of the invention, senders can alternatively or additionally initiate payments by sending a text message 311 to the financial entity, the text message including the receiver's phone number, email address, social networking ID, nickname, or other alias. In some embodiments, senders can alternatively or additionally use the financial institution's online banking website 312 to initiate a payment using an alias, as described in greater detail below with respect to FIGS. 4-12F. Whether via a mobile banking handset application 307, mobile website 309, short message service 311, or online banking website 312, a customer 317 associated with the financial entity may receive funds at the receiver's financial institution account (e.g., DDA, savings, or credit account 313 or P2P-specific account 315). A receiver 321 not associated with the financial entity may receive funds at the receiver's financial institution account 319 at another partner financial institution if the account is registered and associated with the alias and/or the receiver 321 may be prompted to register for the service and/or open an account with the financial institution in order to receive the payment from the sender 301.

It should be appreciated that embodiments of the invention described above permit an entity to send money to another entity even if the sending entity does not know any account information for the recipient entity and only knows a mobile telephone number or email address of the recipient entity. This can also result in better protection of personal account information. It should also be appreciated that some embodiments of the invention create a viral registration and/or account opening system that allows for customers of a financial institution to send payments to anyone outside the financial entity using an alias. In such embodiments, the non-customers are contacted using the alias and they are allowed to quickly open and/or register an account with the financial institution in order to receive the funds from the sender.

As described above, FIG. 1 provides an overview of an invoicing and eBilling system, including P2P payments, and FIGS. 2 and 3 provide an overview of the alias-type P2P payment system and process of embodiments of the invention. FIGS. 3-12F, described below, provide a more detailed description of some systems and methods of implementing embodiments the invention in an online banking environment.

### Online Banking P2P Payment System and Environment

FIG. 4 provides a block diagram illustrating an online banking P2P payment system and environment 400, in accordance with an embodiment of the invention. As illustrated in FIG. 4, the P2P payment environment 400 includes a merchant 410 and a user 420 where one user wants to send funds to the other user. A user of the system may be a person, but may also be a business (e.g., a merchant), customer or a merchant, or any other entity capable of sending or receiving money.

The environment 400 also includes a personal computing device 500 and 600 for the merchant 410 and user 420, respectively. Each personal computing device may be any device that employs a processor and memory and can perform computing functions, such as a personal computer or a mobile device. As used herein, a “mobile device” is any mobile communication device, such as a cellular telecommunications device (i.e., a cell phone or mobile phone), personal digital assistant (PDA), a mobile Internet accessing device, or other mobile device.

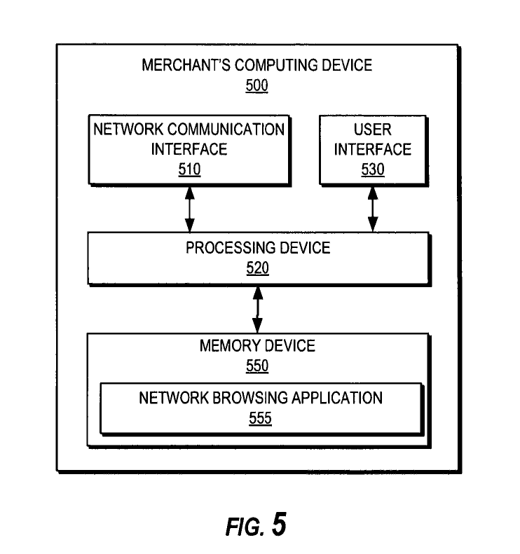

The personal computing devices 500 and 600 are configured to communicate over a network 450 with a financial institution's online banking system 700 and, in some cases, one or more other financial institution banking systems. The merchant's personal computing device 500, the user's personal computing device 600, the financial institution's online banking system 700, an alias data repository 800, and any other participating financial institution's banking systems 470 are each described in greater detail below with reference to FIGS. 5-8. The network 450 may include a local area network (LAN), a wide area network (WAN), and/or a global area network (GAN). The network 450 may provide for wireline, wireless, or a combination of wireline and wireless communication between devices in the network. In one embodiment, the network 450 includes the Internet.

In general, a personal computing device 500 is configured to connect with the network 450 to log the merchant 410 into an online banking system 700. The online banking system 700 involves authentication of a merchant in order to access the merchant's account on the online banking system 700. For example, the online banking system 700 is a system where a merchant 410 logs into his/her account such that the merchant 410 or other entity can access data that is associated with the merchant 410. For example, in one embodiment of the invention, the online system 700 is an online banking system maintained by a financial institution. In such an embodiment, the merchant 410 can use the personal computing device 500 to log into the online banking system to access the merchant online banking account. Logging into the online banking system 700 generally requires that the merchant 410 authenticate his/her identity using a user name, a passcode, a cookie, a biometric identifier, a private key, a token, and/or another authentication mechanism that is provided by the merchant 410 to the online banking system 700 via the personal computing device 500.

The financial institution's online banking system 700 is in network communication with other devices, such as other financial institutions' banking systems 470, an alias data repository 800, and a second personal computing device 600 that is configured to communicate with the network 450 to log the user 420 into the online banking system 700.

In some embodiments of the invention, the alias data repository 800 is configured to be controlled and managed by one or more third-party data providers (not shown in FIG. 4) over the network 450. In other embodiments, the alias data repository 800 is configured to be controlled and managed over the network 450 by the same entity that maintains the financial institution's online banking system 300. In other embodiments, the alias data repository 800 is configured to be controlled and managed over the network 450 by the financial institution implementing the online payment system of the present invention. In still other embodiments, the alias data repository 800 is a part of the online banking system 700.

Referring now to FIG. 5, the personal computing device 500 associated with the merchant 410 includes various features, such as a network communication interface 510, a processing device 520, a user interface 530, and a memory device 550. The network communication interface 510 includes a device that allows the personal computing device 500 to communicate over the network 450 (shown in FIG. 4). In addition, a network browsing application 555 is stored in the memory device 550. The network browsing application 555 provides for the merchant to establish network communication with the online banking system 700 (shown in FIG. 4) for the purpose of initiating online payment, in accordance with embodiments of the present invention.

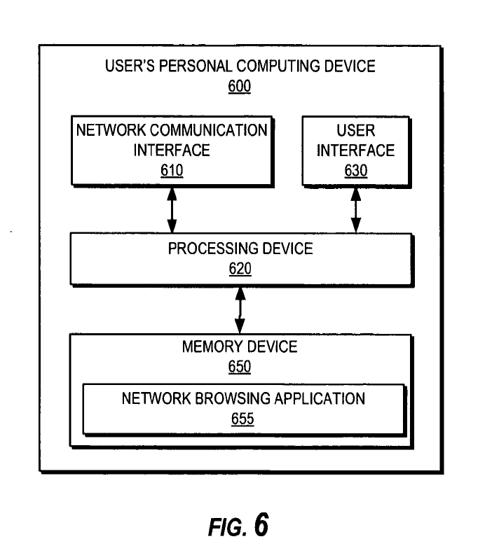

Referring now to FIG. 6, the personal computing device 600 associated with the user 420 also includes various features, such as a network communication interface 610, a processing device 620, a user interface 630, and a memory device 650. The network communication interface 610 includes a device that allows the personal computing device 600 to communicate over the network 450 (shown in FIG. 4). In addition, a network browsing application 655 is stored in the memory device 650. The network browsing application 655 provides for the user to establish network communication for the purpose of registering and account and/or alias with the online payment system and/or receiving online payment, in accordance with embodiments of the present invention.

As used herein, a “processing device,” such as the processing device 520 or the processing device 620, generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 520 or 620 may further include functionality to operate one or more software programs based on computer-executable program code thereof, which may be stored in a memory. As the phrase is used herein, a processing device 520 or 620 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “user interface” 530 or 630 generally includes a plurality of interface devices that allow a customer to input commands and data to direct the processing device to execute instructions. As such, the user interface 530 or 630 employs certain input and output devices to input data received from the merchant 410 or user 420 or output data to the merchant 410 or user 420. These input and output devices may include a display, mouse, keyboard, button, touchpad, touch screen, microphone, speaker, LED, light, joystick, switch, buzzer, bell, and/or other customer input/output device for communicating with one or more customers.

As used herein, a “memory device” 550 or 650 generally refers to a device or combination of devices that store one or more forms of computer-readable media and/or computer-executable program code/instructions. Computer-readable media is defined in greater detail below. For example, in one embodiment, the memory device 550 or 650 includes any computer memory that provides an actual or virtual space to temporarily or permanently store data and/or commands provided to the processing device 520 or 620 when it carries out its functions described herein.

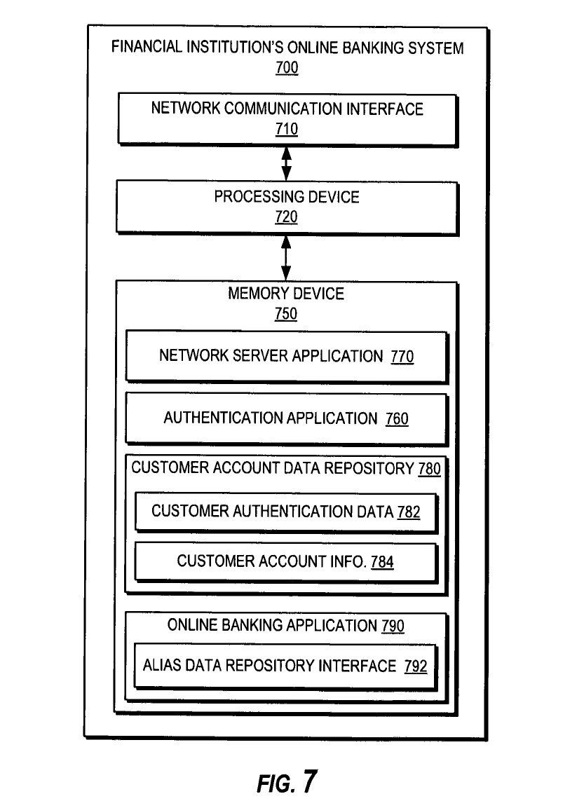

FIG. 7 provides a block diagram illustrating the online banking system 700 in greater detail, in accordance with embodiments of the invention. As illustrated in FIG. 7, in one embodiment of the invention, the online banking system 700 includes a processing device 720 operatively coupled to a network communication interface 710 and a memory device 750. In certain embodiments, the online banking system 700 is operated by a first entity, such as a financial institution, while in other embodiments, the online banking system 700 is operated by an entity other than a financial institution.

It should be understood that the memory device 750 may include one or more databases or other data structures/repositories. The memory device 750 also includes computer-executable program code that instructs the processing device 720 to operate the network communication interface 710 to perform certain communication functions of the online banking system 700 described herein. For example, in one embodiment of the online banking system 700, the memory device 750 includes, but is not limited to, a network server application 770, an authentication application 760, a customer account data repository 780, which includes customer authentication data 782 and customer account information 784, and an online banking application 790, which includes an alias data repository interface 792 and other computer-executable instructions or other data. The computer-executable program code of the network server application 770, the authentication application 760, or the online banking application 790 may instruct the processing device 720 to perform certain logic, data-processing, and data-storing functions of the online system 700 described herein, as well as communication functions of the online banking system 700.

In one embodiment, the customer account data repository 780 includes customer authentication data 782 and customer account information 784. The network server application 770, the authentication application 760, and the online banking application 790 are configured to implement customer account information 784, the customer authentication data 782, and the alias data repository interface 792 when authenticating the sender 201 to the online banking system 700. The customer account information 784, the customer authentication data 782, and the alias data repository interface 792 are discussed in more detail in a later section.

As used herein, a “communication interface” generally includes a modem, server, transceiver, and/or other device for communicating with other devices on a network, and/or a user interface for communicating with one or more customers. Referring again to FIG. 7, the network communication interface 710 is a communication interface having one or more communication devices configured to communicate with one or more other devices on the network 450, such as the personal computing device 500 or 600, the online banking system 700, the other financial institution banking systems 470, and the alias data repository 800. The processing device 720 is configured to use the network communication interface 710 to transmit and/or receive data and/or commands to and/or from the other devices connected to the network 450.

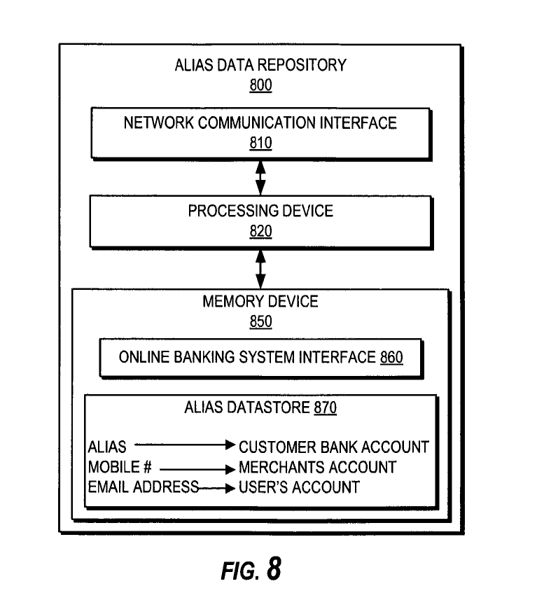

FIG. 8 provides a block diagram illustrating an alias data repository 800, in accordance with an embodiment of the invention. In one embodiment of the invention, the alias data repository 800 is operated by a second entity that is a different or separate entity from the first entity (e.g., the financial institution) that, in one embodiment of the invention, implements the online banking system 700. In one embodiment, the alias data repository 800 could be part of the online banking system 700. In another embodiment, the alias data repository 800 is a distinct entity from the online banking system 700. As illustrated in FIG. 8, the alias data repository 800 generally includes, but is not limited to, a network communication interface 810, a processing device 820, and a memory device 850. The processing device 820 is operatively coupled to the network communication interface 810 and the memory device 850. In one embodiment of the alias data repository 800, the memory device 850 stores, but is not limited to, an online banking system interface 860 and an alias data store 870. The alias data store 870 stores data including, but not limited to, an alias for the customer's financial institution account, mobile number or email address for the merchant's 410 account, and a mobile number and/or email address for the user's 420 account. In one embodiment of the invention, both the online banking system interface 860 and the alias data store 870 may associate with applications having computer-executable program code that instructs the processing device 820 to operate the network communication interface 810 to perform certain communication functions involving the alias data store 870 described herein. In one embodiment, the computer-executable program code of an application associated with the alias data store 870 may also instruct the processing device 820 to perform certain logic, data processing, and data storing functions of the application associated with the alias data store 870 described herein. An alias, as defined in this invention, is not limited to just a mobile device number or an email address.

The network communication interface 810 is a communication interface having one or more communication devices configured to communicate with one or more other devices on the network 450. The processing device 820 is configured to use the network communication interface 810 to receive information from and/or provide information and commands to a personal computing device 500 or 600, other financial institution banking systems 470, the alias data repository 800, the online banking system 700 and/or other devices via the network 450. In some embodiments, the processing device 820 also uses the network communication interface 810 to access other devices on the network 450, such as one or more web servers of one or more third-party data providers. In some embodiments, one or more of the devices described herein may be operated by a second entity so that the third-party controls the various functions involving the alias data repository 800. For example, in one embodiment of the invention, although the online system 700 is operated by a first entity (e.g., a financial institution), a second entity operates the alias data repository 800 that stores the alias details for the customer's financial institution accounts and other information about customers.

As described above, the processing device 820 is configured to use the network communication interface 810 to gather data from the various data sources. The processing device 820 stores the data that it receives in the memory device 850. In this regard, in one embodiment of the invention, the memory device 850 includes datastores that include, for example: (1) aliases for customer financial institution account numbers and routing information, (2) information about sending and receiving users' mobile device numbers, email addresses, or other contact information, which may have been received from the online banking system 700; (3) a list of customer IDs or authentication data received from the online banking system 700; and/or (4) customer credentials (e.g., a customer ID) received from the merchant's personal computing device 500 or received from the online system 400 in response to the merchant accessing the online banking system 700.

### Online Invoicing and eBill Process and Interface

FIGS. 9A-9C provide flow charts illustrating a process 900 for invoicing and electronic billing, in accordance with an embodiment of the invention. FIGS. 9A-9C illustrate the flow chart in terms of “swim lanes” associated with entities which may perform the operations in each respective swim lane. The entities illustrated in the exemplary Figures are a financial institution's online banking system, a user using a personal computing device, an alias data repository, and a merchant using a computing device. However, it should be noted that other entities could also be involved and some embodiments of the invention may not be limited to the four entities illustrated in FIGS. 9A-9C. Additionally, it should be understood that, in other embodiments of the invention, the entities need not be required to perform the actions illustrated in each respective swim lane. For example, some of the process steps described herein may be performed by the first entity (or other entities) even though the element may be illustrated as in the swim lane of the second entity. Similarly, in some embodiments, some of the process steps may be performed by the second entity (or other entities) even though the element may be illustrated as in the swim lane of the first entity.

The process begins with block 902 of FIG. 9A where a merchant using a computing device requests eBill service. In some embodiments, the merchant uses a financial institution's online banking system to register for the eBill service. In block 904 a financial institution's online banking system presents terms and prompts user to accept. Typically, the GUI will contain an explanation of the eBill service, fees, consent to the terms of the agreement, and other requirements. In block 906, the merchant accepts the terms. For example, the user may click a box presented in the GUI accepting the terms of the agreement. In block 908, the eBill GUI is presented so that the merchant can input all the information needed to use the eBill service. FIG. 10A shows this eBill GUI where the online banking system 700 present various sub-tabs under the tab heading. These sub-tabs include a sub-tab for making a transfer, a sub-tab for reviewing transfers, a sub-tab for adding recipients, a sub-tab for managing accounts, and a sub-tab for invoicing and eBill. As shown in FIG. 10A, the online banking system 700 also presents a help box that is configured to provide hyperlinks to help information, including a link to (1) what the merchant can do using the online banking system 700, (2) what the merchant needs to know, and (3) what else the merchant can do using the online banking system 700.

Returning to FIG. 9A, the merchant inputs invoicing data as shown in block 910. FIG. 10A shows an option of uploading invoices and an option for manually entering invoice information. The merchant can click on the “Browse” button to upload a file (e.g., a text document, a PDF file, an image file, etc.). In some embodiments, the merchant can preview the uploaded invoice. As shown in FIG. 10A, the invoice may include a bar code that can be scanned to pull up the information contained in the invoice. The invoice may also include contact information of the merchant and customer or entity billed, the date of the invoice, the invoice number, the total amount due, the due date of the payment, product description, quantity of products, and the price of each product. Referring again to FIG. 9A, the invoice data is processed as shown in block 912. In some embodiments, the online banking system 700 is configured to scan the information to extract the data. For example, the online banking system 700 may require that the merchant place each potion of information in a particular order so that the information contained in the image can be extracted through optical character imaging. In other embodiments, the invoice data is stored in an invoice database. In other embodiments, the online banking system 700 is configured to convert the invoice data into an electronic bill.

In block 914 of FIG. 9A, a user is identified based on the invoicing data. In some embodiments, the online banking system 700 is configured to search the invoice data to determine that the user is associated with a payment. In block 915, the online banking system 700 is configured to determine that the user owes the merchant a payment amount. For example, the online banking system 700 may search for specific terms such as “total due” and an associated dollar amount to determine that a payment is owed by the user. The merchant may also, for example, manually input the payment amount. In some embodiments, the merchant adds a new user. For example, the merchant may manually input the name, email address, and a payment amount to add a new user using the online banking system 700. In still other embodiments, the online banking system 700 determines that the merchant owes the user a payment amount.

In block 918, the online banking system 700 is configured to store the user's information in the merchants list of P2P eBill recipients. In some embodiments, the merchant can simply choose from a list of users to either collect or transfer money to the designated user. In FIG. 10B, under the “Manage Accounts” sub-tab and the tab labeled “eBill”, the merchant can view saved users, edit the saved users, and add new users. As shown in the screen shot of FIG. 10B, information such as the name of customers, mailing addresses, email addresses, phone numbers, nick names, account numbers of the customer, the total due, and the due date are easily viewed by the merchant. Further, the merchant can choose from a list of the saved users to select a saved user and edit the information related to that user. For example, if the saved user list is missing an address, the merchant can edit the saved users list and add the address. Further, the merchant can also select a saved user to delete from the list of saved users.

In block 920, the merchant collects a payment amount from the user as further shown in FIGS. 9B-10H. It will be understood that the online banking system 700 can also be used to determine that the merchant owes money to a user. In cases where the merchant owes money to the user, the merchant, in some embodiments, follows the same process as shown in FIGS. 9B-12F.

In block 922 of FIG. 9B, a financial institution's online banking system 700 invites a user to participate in a P2P payment program. In some embodiments, the invitation is communicated via a “push” text message, an email, and or/an online banking account. In some embodiments, the invitation comprises an electronic bill. FIG. 10C provides a screenshot of a graphical user interface used during the process of inviting a user to participate in a P2P payment program. In the illustrated embodiment, the screenshot is located under the “Transfers” tab on a merchant's online banking homepage. Although in other embodiments the information depicted in the screenshot of FIG. 10C may be presented elsewhere within the online banking system. In certain embodiments, the page illustrated in the screenshot is available after the user has logged into the user's online banking account. In another embodiment, the page illustrated in the screenshot may be available before the user has logged into the user's online banking account. The other tabs on the user's online banking homepage are a tab related to accounts, a tab related to paying bills, a tab related to investments and a tab related to customer service. It will be understood that the online banking homepage may include any number of tabs and sub-tabs. In one embodiment shown in FIG. 10C, the online banking system 700 indicates to the user that he or she is invited to participate in the P2P transfer service via an alias. The information provided in the screenshot of FIG. 10C is configured to inform the user that he or she can send money to a recipient's email address or mobile number or, in other embodiments, some other alias and can receive money using just an email address or mobile number or, in other embodiments, another alias as identifying information. The online banking system 700 informs the user in FIG. 10C that the user can send money to a user by submitting to the online banking system 700 the user's email address or mobile number. As shown in FIG. 10C, the online banking system 700 informs the user that the user can receive money from a user by setting up the user's P2P account on the online banking system 700 and verifying the user's email address or mobile number. As shown in FIG. 10C, the online banking system 700 also informs the user that the P2P service is the newest and easiest way to make transfers, and that money can be transferred without providing a recipient's account number. As shown in FIG. 10C, the online banking system 700 finally asks the user whether he or she would like to try this P2P feature. As shown in FIG. 10C, the online banking system 700 provides two buttons for the user to communicate his or her decision to the online banking system 700. A user can activate the “Yes, I want to Join” button if the user wishes to initiate the process of using the P2P service. Alternatively, the user can activate the “No thanks” button if the user wishes to decline the invitation extended by the online banking system 700. In certain embodiments of the invention, the online banking system 700 only invites certain existing online banking customers who fit certain criteria, including, but not limited to, pre-determined minimum account balance, number of years since the customer first opened an account, customer status, etc. Thus, in such embodiments, the information provided in the screenshot of FIG. 10C may only be accessible to those qualified customers as determined by the financial institution.

Returning to FIG. 9B, the process then moves to block 924 where the user 420 using personal computing device 600 accepts the invitation that is shown on FIG. 10C by activating the button that reads “Yes, I Want to Join.”

The process then moves to block 926 of FIG. 9B where the online banking system 700 presents to the user the terms of the P2P transfer feature that will govern the transfer of funds. A screenshot for this process is shown in FIG. 10D. FIG. 10D shows that the online banking system 700 informs the user of the merits of using the P2P transfer service. As shown in FIG. 10D, these merits include, but are not limited to, making person-to-person transfers of money by using an email address or phone number, without the need of providing an account number. Additionally, the information provided in the screenshot depicted in FIG. 10D informs the user that a fee is associated with transferring funds to another person using the recipient's mobile number or email address or other alias. The online banking system 700 also informs the user that the amount of any fee is disclosed prior to making the P2P transfer via alias. The online banking system 700 also informs the user that he or she can read more details about this fee in the service agreement that is linked into the page displayed as a screenshot in FIG. 10D. The online banking system 700 also informs the user that there may be dollar amounts and other limits that apply for these P2P transfers via alias. As shown in FIG. 10D, the online banking system 700 further informs the user that the user may find in the service agreement applicable daily cut off times and delivery times for making these P2P transfers via alias. The information provided in the screenshot of FIG. 10D also informs the user that no fee is associated with transferring funds to another person if the user provides the recipient's account number. In the illustrated embodiment the recipient's account number must be an account associated with the financial institution implementing the online banking system, however, in other embodiments the recipient's account number may be an account number associated with another financial institution. FIG. 10D also illustrates a confirmation check box which the user may activate if the user confirms that he or she a) has read and agrees to the terms of the service agreement, including the terms of the Email/Mobile Network Transfer section; b) consents to receive email and automated text messages about Email/Mobile Transfers; c) will only register mobile numbers where he or she is the account holder; or if he or she is not the account holder, then he or she has the account holder's permission to register that mobile number; and d) will obtain the consent of the person to whom he or she wants to send a Mobile Transfer text message to receive the automated text message. As shown in FIG. 10D, the online banking system 700 is configured to provide the service agreement label as a hyperlink or some other activatable form, which may be activated so that the user can read the service agreement that governs the P2P transfer via alias. As shown in FIG. 10D, the online banking system 700 provides a checkbox that the user has to click to confirm he or she has met each of the four requirements listed above. Until the user activates this checkbox to confirm that he or she meets the four requirements listed above, the online banking system 700 provides a non-activatable “I Agree” button and an activatable “I Don't Agree” button. If the user activates the “I Don't Agree” button, the online banking system 700 will not permit the user to continue with setting up the P2P transfer via alias. Once the user activates the confirmation check box, the online banking system 700 will turn the non-activatable “I Agree” button into a activatable “I Agree” button. Then, the user still has a choice of either activating the “I Agree” button or activating the “I Don't Agree” button. If the user activates the “I Don't Agree” button, the online banking system 700 will not permit the user to continue with setting up the P2P payment transfer via alias. FIG. 10D also shows that the user can get help about learning about the P2P transfer process or the service agreement by texting a code to a number listed on the page. FIG. 10D also shows that the user can cancel the user's plan by texting a code to a number listed on the page. FIG. 10D also shows that the user can call a number listed on the webpage to get more help.

Returning to FIG. 9B, the process then moves to block 928 of FIG. 9B. The user accepts the terms of the P2P service by activating the checkbox that confirms that the user meets all the four requirement described in the previous paragraph, and then activating the “I Agree” button to indicate the user's willingness to proceed with setting up the P2P transfer via alias.

The process then moves to block 930 of FIG. 9B where the online banking system 700 presents a transfer GUI so that the user can input all the information required to make the transfer. FIG. 10E shows this transfer GUI where the online banking system 700 presents four sub-tabs under the tab heading. These four sub-tabs are a sub-tab for a making a transfer, a sub-tab for reviewing transfers, a sub-tab for adding recipients, and a sub-tab for managing accounts. FIG. 10E also shows that under the sub-tab for making transfers, the merchant has the option of making a transfer within the financial institution by activating a corresponding tab and the user also has the option of making a transfer outside the financial institution by activating the corresponding tab. As shown in FIG. 10E, the online banking system 700 also presents activatable hyperlinks for adding a new transfer recipient, setting up and starting the use of the P2P feature via alias, and for learning more about the P2P feature via alias. FIG. 10E also show that under the first sub-tab for making transfers, the user has the option of making an internal transfer (i.e., within the bank) by activating a corresponding tab and the user also has the option of making an external transfer (i.e., outside the bank) by activating the corresponding tab. Under the sub-tab for making internal transfers, the online banking system 700 presents a drop-down list that lists all the accounts from which the user can transfer money. The online banking system 700 also presents a drop-down list that lists all the recipients (full name or nickname and either a corresponding alias type or financial institution account type) to whom the user can transfer money. In one embodiment, only the nickname of the recipient and the associated alias type or financial institution account type are listed in the drop-down list. The online banking system 700 also presents a text box where the user can input the amount of money that the user intends to transfer to the intended recipient. In one embodiment, the online banking system 700 presents a drop-down list which lists several frequency options if the user wants to periodically make the same transfer. In addition, the frequency drop-down list is configured to allow the user to select a one-time transfer option with the transfer occurring immediately or at a preconfigured time in the future. The online banking system 700 also presents the fee that the user will incur if the user proceeds with the P2P transfer. As previously discussed, in specific embodiments, user fees may be associated with alias type transfers, (i.e., transfers to an email address, mobile telephone number, etc.) while no fee may be associated with a financial institution account transfer. The online banking system 700 also presents to the user activatable help text near the transfer fee if the user wants to understand how the transfer fee was computed. The online banking system 700 also presents a button to indicate to the online banking system 700 that the user has entered all the required information and intends to continue with the P2P transfer.

Returning the reader to FIG. 9B, the process then moves to block 932, at which a transfer account is selected from the drop-down list of user bank accounts. In some embodiments, the transfer account is associated with the user. As indicated in FIG. 10F, under the sub-tab for making internal transfers within the bank, the user selects the appropriate account from drop-down list that lists all the accounts from which the user can transfer money.

The process then moves to block 934 of FIG. 9B, at which the transfer amount is entered. As indicated in FIG. 10F, the user inputs into the amount textbox the amount of money that the user intends to transfer to the intended recipient. In one embodiment, the user selects an appropriate frequency option from a drop-down list which lists several frequency options, such as, a one-time, immediate transfer, a one-time future transfer, a periodic transfer over a preconfigured cycle or the like.

In block 936, the online banking system 700 determines whether the total transfer amount exceeds the maximum permitted in the transaction. In one embodiment, the maximum amount that can be transferred using the P2P service is dependent on several factors including, but not limited to, the user's identity, the recipient's identity, the length and nature of the user's relationship with the financial institution, the length and nature of the recipient's relationship with the financial institution, the amount of funds that the user has deposited at the financial institution, the user's financial institution status, etc. In one embodiment, the maximum amount that can be transferred using the P2P transfer method is dynamically determined at the time the transfer is set-up by a supporting application that works in conjunction with or is embedded within the online banking system 700.

If the transfer amount is above the maximum permitted in this particular transaction, the process moves to block 938 of FIG. 9B and the online banking system 700 displays an error message to the user.

If the transfer amount is below or equal to the maximum permitted in this particular transaction, the process moves to block 940 of FIG. 9B where the online banking system 700 requests the user's confirmation of the transfer and notice of recipient consent as indicated on the screenshot provided in FIG. 10G. As shown in FIG. 10G, the online banking system 700 displays a text message asking whether the user wants to make the transfer. As shown in FIG. 10G, the online banking system 700 also displays the account from which funds will be transferred if the user chooses to proceed with the transfer, the recipient's nickname of the recipient and alias type or financial institution account type, the amount of money that will be transferred if the user chooses to proceed with the transfer, the transfer fee that will be incurred by the user if the user chooses to proceed with the transfer, the total amount of the transaction if the user chooses to proceed with the transfer, the account from which the user executes the transfer if the user chooses to proceed with the transfer, etc. In another embodiment of the invention, an entity or person other than the user will incur the transfer fee. In one embodiment, only a few characters of the identifying 10G information for the sending account are displayed. As shown in FIG. 10H, the online banking system 700 informs the user that the selected recipient's email or mobile device must be set up to receive transfers via the P2P service described herein. As shown in FIG. 10H, the online banking system 700 also informs the user that the online banking system 700 will notify the selected recipient using the email address or mobile number provided by the user. As shown in FIG. 10H, the online banking system 700 also informs the user that the transfer will be canceled if the selected recipient does not set up a P2P alias transfer account within a preconfigured number of days, for example fourteen days or the like. As shown in FIG. 100, the online banking system 700 presents two decision buttons to the user. The first decision button is activatable to confirm the user's intention to make a transfer, and the second button is activatable to decline the transfer. As shown in FIG. 10G, the online banking system 700 also presents a checkbox to the user where the user, by checking or otherwise activating the box, confirms that the user has obtained the consent of the selected recipient to receive text messages or other forms of communication associated with the transfer of funds from the user to the selected recipient. Once the user checks or otherwise activates this checkbox, the first button associated with confirming the user's intention to make a transfer moves from a dormant state to an activatable state.

Returning to FIG. 9B, the process then moves to block 942 where the user can activate the first button associated with confirming the user's intention to make a transfer. Alternatively, the user can activate the second button associated with canceling the transaction. Once the user activates the button confirming the transfer, as shown in FIG. 10G, the online banking system 700 displays a message to the user that the transfer request has been received by the online banking system 700 and that the recipient has been notified. As shown in FIG. 10H, the confirmation page displays an identifier from the account from which money will be transferred along with the new account balance after the deducting the total amount for the transfer. As shown in FIG. 10H, the confirmation page also displays the nickname of the recipient to whom the money will be transferred and the associated alias type. The confirmation page also displays the amount transferred, the fee associated with the transaction, the transfer date, and a unique confirmation number. The online banking system 700 also provides a button on the page so that the user can choose to make another transfer. The online banking system 700 also provides activatable text for the user to return to the previous screen of the P2P transfer process. As shown in FIG. 10H, the online banking system 700 informs the user that the selected recipient's email or mobile device must be set up to receive transfers via the P2P service. As shown in FIG. 10H, the online banking system 700 also informs the user that the online banking system 700 will notify the selected recipient using the email address or mobile number provided by the user. As shown in FIG. 10H, the online banking system 700 also informs the user that the transfer will be canceled if the selected recipient does not set up a P2P transfer account within a pre-determined number of days.

Referring to FIG. 9C, the process then moves to block 944 where the online banking system 700 determines if the recipient is associated with an alias or a financial institution account number. If the recipient is associated with a financial institution account number, the process moves to block 954 where the online banking system 700 uses the financial institution account number to initiate an Automated Clearing House (ACH) transfer or other type of transfer. If the recipient is associated with an alias, then, the process moves to block 946 where the online banking system 700 sends the alias and the recipient's name to an alias data repository 800.

The process then moves to block 948 where the alias data repository 800 looks up the alias in an alias datastore. Then the process moves to block 950, where the alias data repository 800 determines that the alias is associated with a financial institution account. If the alias is associated with a financial institution account, then the process moves to block 952 where, if the alias data repository 800 determines that the provided name matches the name in the datastore, then the process moves to block 954 of FIG. 9C where the online banking system 700 uses the financial institution account number to initiate an ACH transfer or other type of transfer. If in block 956 of FIG. 9C, the provided name does not match a name in datastore, then the online banking system 700 displays an error message to the user that the transfer cannot be completed. In block 955, the online banking system 700 provides notification to the user that transfer/notice of transfer request to the user has been initiated.

### Online Banking Alias Registration and P2P Payment Receive Process and Interface

FIGS. 11A-11C provide flow charts illustrating a process 1000 for receiving P2P payments, in accordance with an embodiment of the invention. FIGS. 11A-11C illustrate the flow chart in terms of “swim lanes” associated with entities which may perform the operations in each respective swim lane. The entities illustrated in the exemplary Figures are a financial institution's online banking system and a merchant (recipient) using a computing device. However, it should be noted that other entities could also be involved and some embodiments of the invention may not be limited to the two entities illustrated in FIGS. 11A-11C. For example, in some embodiments, the recipient is the user. Additionally, it should be understood that, in other embodiments of the invention, the entities need not be required to perform the actions illustrated in each respective swim lane. For example, some of the process steps described herein may be performed by the first entity (or other entities) even though the element may be illustrated as in the swim lane of the second entity. Similarly, in some embodiments, some of the process steps may be performed by the second entity (or other entities) even though the element may be illustrated as in the swim lane of the first entity (or even in the customer swim lane).

The process 1000 in FIG. 11A starts with block 1005 where an online banking system 700 using the alias, such as an email address or mobile telephone number, sends a merchant (recipient) notice of a eBill requested transfer from a user, the notice including a link to the online banking system 700 and a confirmation number.

The process then proceeds to block 1010 where a merchant (recipient) activates the link provided with the notice. And in block 1015, the online banking system 700 provides and “accept” transfer GUI.

The process proceeds to the screenshot of a page as shown in FIG. 12A where the online banking system 700 presents a sign-in page. The online banking system 700 alerts the merchant (recipient) that to accept the transfer, the merchant will need an eligible checking or saving account at a participating bank. For customers who hold accounts at the financial institution that manages the online banking system 700, the online banking system 700 presents a widget with a textbox that allows the merchant to enter login or other authenticating information. The online banking system 700 also provides a link for the merchant to enroll with the financial institution's online banking system. For customers of other participating financial institutions, the online banking system 700 provides a sign-in button, which may be configured to either display a sign-in widget on the instant page or provide a link to another page where the merchant can enter login information for the participating financial institution. The online banking system 700 also notifies the merchant that if the merchant does not have an account with one of the participating banks, that merchant can open an account at the financial institution that maintains the online banking system 700. The online banking system 700 notifies the merchant that he or she may review the terms of opening a new account at this financial institution, including any fees that may be incurred by the merchant in opening this new account. The online banking system 700 also notifies the merchant that if the merchant does not want to open a new financial institution account, the merchant may notify the sender to arrange an alternate transfer method. The online banking system 700 also notifies the merchant that the transaction will be canceled if it is not accepted within a pre-determined period of time.

The process then proceeds to block 1020 of FIG. 11A where the merchant (recipient) determines whether the merchant has an account with the financial institution that manages the online banking system 700. If the merchant has a financial institution account with the financial institution that manages the online banking system 700, then the process proceeds to block 1050 where the merchant enters authentication information into the textbox shown in FIG. 12A.

As shown in FIG. 11A, if the merchant does not have a financial institution account with the financial institution that manages the online banking system 700 then the process proceeds to block 1022 where the merchant determines whether the merchant has an account with participating financial banks or financial institutions. If the merchant has a financial institution account with a participating financial institution, the process proceeds to block 1040 where the merchant can select the participating financial institution sign-in link as described previously and illustrated on FIG. 12A. The process then proceeds to block 1045 where the online banking system 700 forwards the merchant to a participating financial institution's website or alternatively, the online banking system 700 opens a widget or an applet on the same window as that shown in FIG. 12A or a new pop-up window.

As shown in FIG. 11A, if, in block 1020, the merchant does not have an account with the financial institution that manages the online banking system 700 and if, in block 1024, the merchant (recipient) does not open a new account with the bank that manages the online banking system 700, then after a defined period of time without recipient (merchant) acceptance, the online banking system 700 cancels the transfer and notifies the user (sender) as shown in block 1026.

As shown in FIG. 11A, in block 1024, if the merchant opens a new account with the bank that manages the online banking system 700, then the merchant, in block 1025, selects the link directing the merchant to open a new account with the bank that manages the online banking system 700. This link described is shown in FIG. 12A and described previously.

As shown in FIG. 11A, the link in block 1025 directs the online banking system 700 to display a new account application GUI to the merchant, which is readily approved and opened for the merchant after receiving any pertinent information that may be required to open and approve a new account at the financial institution that manages the online banking system 700 as shown in block 1030. The process then proceeds to block 1050 in FIG. 11A where the merchant enters authentication information into the textbox shown in FIG. 12A.

The process then moves to block 1060 on FIG. 11B where the online banking system 700 prompts the merchant to enter a confirmation number received with the transfer notice and agree to the terms governing the transfer. A screenshot for the GUI that handles this process is shown in FIG. 12B. As shown in FIG. 12B, the online banking system 700 indicates to the merchant that this is the start of the procedure to accept a transfer to money to the merchant's email address or mobile number. As shown in FIG. 12B, the online banking system 700 prompts the merchant to enter the received confirmation number in a checkbox. As shown in FIG. 12B, the page also has two buttons—a first button configured for the merchant to indicate the desire to proceed with accepting the transfer and a second button configured for the merchant to indicate the desire to not proceed with the transfer. As shown in FIG. 12B, the first button can change from a dormant state to an activatable state by checking the check-box to confirm that the merchant has a) has read and agrees to the terms of the service agreement, including the terms of the Email/Mobile Network Transfer section; b) consents to receive email and automated text messages about Email/Mobile Transfers; c) will only register mobile numbers where the merchant is the account holder; or if the merchant is not the account holder, he or she has the account holder's permission to register that mobile number; and d) will obtain the consent of the person to whom he or she wants to send a Mobile Transfer text message to receive the automated text message. In one embodiment, the merchant has to always go through the procedure of accepting the transfer. In other embodiments, the merchant does not have to go through the procedure accepting the transfer for any transfer after the first transfer.

Subsequently, in block 1065 of FIG. 11B, the merchant enters a confirmation number in the appropriate textbox as shown in FIG. 12B and agrees to the terms that govern the transaction by activating the appropriate checkbox. The merchant then activates the first button to continue the process of accepting the transfer.

The process then proceeds to block 1068 of FIG. 11B where the online banking system 700 uses the confirmation number entered in block 1065 to identify or confirm the transfer request.

Then the process proceeds to block 1070 of FIG. 11B where the online banking system 700 prompts the merchant to register the alias to which transfer notice was sent. A screenshot of this registration page is shown in FIG. 12C. As shown in FIG. 12C, the online banking system 700 indicates to the merchant that if the merchant has received a notice that funds were sent to the merchant, then the merchant will need to set up to accept transfers to the same email address or mobile number that received the transfer notice. The page shows a first textbox where the user can enter the alias that received the transfer notice, and a second textbox where the user can confirm the alias entered in the first textbox by re-entering the alias in the second textbox. The online banking system 700 also prompts the user to select the appropriate account to link to the alias that will receive the funds by selecting the appropriate account from a drop down list. The online banking system 700 also prompts the user to check a checkbox, whereby the merchant by checking the checkbox agrees that by registering the alias, he or she is the alias account holder, or has the alias account holder's permission to register it, and consents to receive email and text messages about alias transfers at this email address or phone number. In some embodiments, the online banking system 700 presents an authentication widget as shown in FIG. 12C and described in further detail below. The page also has two buttons—a first button configured to allow the merchant to indicate a desire to proceed with receiving the transfer and a second button configured to allow the merchant to indicate a desire not to proceed with receiving the transfer. This first button only becomes activatable after the merchant enters all the required information on the page and has been further authenticated, as in some embodiments. In one embodiment, the online banking system 700 also saves the information entered on this page, so that the merchant does not have to re-register an alias every time the merchant receives a P2P transfer.

The process then proceeds to block 1075 where the merchant enters the alias in the appropriate textbox, confirms the alias in the appropriate textbox, selects the account to receive the funds from the drop-down list shown in FIG. 12C, and checks the checkbox that indicates that the merchant accepts the terms that govern the transfer. In some embodiments, the accounts listed in the drop-down list are identified by a few digits of the account number.

In some embodiments, the process then proceeds to block 1077 where the online banking system 700 requires additional authentication to register an alias. As illustrated on FIG. 12C, the online banking system 700 displays a widget which serves as an additional authenticating step before saving the information of the merchant's associated alias. The online banking system 700 indicates to the merchant that by activating the button in the widget for sending a code, the merchant will receive a code on his or her mobile device. In another embodiment, the merchant may receive a code through other means such as email, postal mail, etc. In one embodiment, the widget is a “Security” widget and the user can send a security code to the merchant's mobile device.

The process then moves to block 1079 of FIG. 11B where the merchant performs an additional authenticating step. As indicated on the screenshot shown in FIG. 12C, the merchant activates the button within the widget for sending a code to the merchant's mobile device. The merchant than receives on his or her mobile device the code that he or she must input into the widget shown in FIG. 12C. Once the merchant inputs the correct code into the widget and activates a button in the widget to confirm that the code is correct, the button that corresponds to adding a new recipient is activatable so that it can now be activated by the merchant. The merchant (recipient) activates this button so that the online banking system 700 can store the merchant's alias. The merchant can activate the first button on the page which indicates that the merchant wishes to proceed with the transfer. The online banking system 700 indicates to the merchant as shown in FIG. 12C that by activating the first button to continue with receiving the transfer, the merchant will receive an enrollment code.

The process then moves to block 1080 of FIG. 11C where the online banking system 700 uses the registered alias to send an enrollment code to the device of the merchant associated with the alias.

The process then moves to block 1082 of FIG. 11C where the online banking system 700 prompts the merchant to enter the enrollment code that the merchant received on the device associated with the alias. A page showing this block is captured on FIG. 12D. The online banking system 700 indicates to the merchant that the merchant must verify the alias (e.g., mobile number) to complete enrollment in the P2P transfer via system. In one embodiment, the page indicates to the merchant that the merchant should expect a text message from the bank that manages the online banking system 700. The page also has activatable text if the merchant would like to know more about the use of enrollment codes. The page as shown in FIG. 12D indicates to the merchant that the enrollment code must be entered into the appropriate textbook in order verify ownership of the mobile number or email address associated with the alias and complete enrollment with the P2P transfer service. As shown in FIG. 12D, the online banking system 700 also indicates to the merchant that the enrollment number expires in a pre-determined number of minutes. After the enrollment number expires, the online banking system 700 will not be able use that enrollment code to verify ownership of the merchant's mobile number associated with the transfer and will not be able to complete the enrollment of the merchant (recipient). The page also has activatable text if the merchant has not received an enrollment code or if the enrollment code has expired. The page indicates to the merchant that messaging and data rates may apply for receiving the enrollment code. The page also has two buttons—a first button configured to allow the merchant to indicate that the merchant does not wish to proceed with the transaction and a second button configured to allow the merchant to indicate that the merchant desires to proceed with receiving the transfer. This second button only becomes activatable after the merchant enters an enrollment code on the page. In some embodiments, this second button only becomes activatable after the merchant enters a valid and unexpired enrollment code on the page.

The process then moves to block 1084 where the merchant enters the enrollment code into the textbox that is shown in FIG. 12D.

The process then moves block 1086 where the online banking system 700 determines if the enrollment code entered by the merchant matches the enrollment code sent by the online banking system 700 to the alias of the merchant.

If the entered code in 1086 does not match the code sent to the alias, then, at block 1087, the online banking system 700 displays an error message to the merchant that the transaction cannot proceed further. In one embodiment, the online banking system 700 allows the merchant to correct any errors in the alias provided by the merchant or in the code received by the merchant. In one embodiment, the online banking system 700 only grants a pre-determined number of unsuccessful attempts to verify the code before rejecting the transfer.

If the entered code in 1086 matches the code sent to the alias, the process moves to block 1088 where the online banking system 700 processes any pending transfers involving the newly registered alias. As shown in FIG. 12E, the online banking system 700 indicates to the user that the verification of the alias has been completed. The online banking system 700 thanks the user for setting up an alias to accept transfers. The online banking system 700 indicates to the merchant that people or entities can now send money to the merchant using the merchant's alias. The online banking system 700 indicates to the merchant that any transfer to the merchant's newly registered alias will be deposited to the account number shown on the page (see FIG. 12E). In one embodiment, the online banking system 700 only shows a pre-determined number of digits of the merchant's financial institution account number. The page also indicates to the merchant that the transfer request is now in process. As shown in FIG. 12E, the page shows details of the transfer, including, but not limited to the name of the sender, the amount, the date on which the sender sent the amount, the confirmation number, and the status of the transfer. The page also includes two buttons—the first button is configured to allow the merchant to add another alias and the second button is configured to allow the merchant to make a transfer using the newly registered alias.

The process then moves to block 1090 where the online banking system 700 sends the alias to the alias data repository 800 along with associated account information to be stored in the alias datastore.

FIG. 12F presents a GUI where the online banking system 700 presents four sub-tabs under the “Transfers” tab described earlier. These four sub-tabs are a first sub-tab for a making a transfer, a second sub-tab for reviewing transfers, a third sub-tab for adding recipients, and a fourth sub-tab for managing accounts. FIG. 12F also shows that under the first sub-tab for making transfers, the merchant has the option of obtaining a set up to accept transfer by activating the associated link. The online banking system 700 indicates to the merchant (recipient) that the merchant may activate this link if the merchant received a transfer notice, i.e., the merchant received an email, text message, or other form of electronic communication that someone has sent funds to the merchant. The online banking system 700 indicates to the merchant that in order to complete the transfer and collect the funds, the merchant must set up the merchant's alias to accept transfers. The online banking system 700 also presents a activatable link configured to allow the merchant to be directed to a page to learn more about this P2P transfer via alias method. The online banking system 700 also presents a help box where the merchant can understand more about what the merchant can do using the online banking system 700, what the merchant needs to know, and what else the merchant can do using the online banking system 700. The online banking system 700 also presents a message to the merchant that transferring money within the bank is fast and free. The online banking system 700 also indicates to the customer that the feature of making a P2P transfer using a recipient's alias is a new feature, and that transfers within the bank now include transfers made using a recipient's alias. Alternatively, a user who intends to receive money using an alias can get set up by clicking on the activatable text associated with getting set up to accept transfers. This option is also illustrated by block 1095 of FIG. 11B where a user who accesses the online banking system 700 can register an alias by selecting an appropriate link. Therefore, in one embodiment, the user does not have to wait to receive a payment using the P2P transfer service before setting up an alias to receive transfers.

In one embodiment of the invention, both the sender and the recipient need to have financial institution accounts registered for P2P transfer via alias. In another embodiment of the invention, the sender needs to have a financial institution account registered for P2P transfer via alias, but the recipient does not need to have a financial institution account registered for P2P transfer via alias. In another embodiment of the invention, the recipient needs to have a financial institution account registered for P2P transfer via alias, but the sender does not need to have a financial institution account registered for P2P transfer via alias.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

1. A method for electronic invoicing and payment comprising:
storing an alias for a merchant in a storage device;
storing at least one invoice associated with the merchant in a storage device, where the invoice is directed for payment by a user; and
associating the alias of the merchant with the at least one invoice via a computing device processor, such that a payment may be remitted to the merchant by reference to the alias.

2. The method of claim 1 further comprising:
receiving payment instructions from the user, wherein the payment instructions include the alias for the merchant.

3. The method of claim 2 further comprising:
determining, via a computing device processor, that the merchant is a registered payment recipient based on the alias; and
applying the payment to the invoice.

4. The method of claim 3, further comprising:
communicating, via a computing device, a payment notification to the merchant based on the merchant being the registered payment recipient.

5. The method of claim 1, further comprising
transmitting, via a computing device, information associated with the invoice to the user;
receiving payment instructions from the user, wherein the payment instructions include the alias for the merchant; and
applying the payment to the invoice.

6. The method of claim 1, further comprising:
determining that the alias is associated with a registered bank account of the merchant.

7. The method of claim 1, wherein the alias comprises an identifier selected from the group consisting of: a mobile telephone number, an email address, a social networking ID, a name, an address, a URL address, a logo, a brand, a picture, graphical art, a trade name, a trade mark, or combinations thereof.

8. The method of claim 1, further comprising:
receiving a search term from the merchant;
matching, via a computing device processor, the search term with the at least one invoice in the storage device;
identifying, via a computing device processor, the user based on the at least one invoice.

9. The method of claim 8, further comprising:
identifying, via a computing device processor, one or more additional users; and
presenting a list of the additional users to the merchant.

10. The method of claim 1, wherein the invoice comprises data selected from the group consisting of: product identification; quantity of items ordered; price of each item; fees for services or products; tax amounts; total amount due; date payment is due; payment history;
explanation of fees; explanation of services; shipping information; or combinations thereof.

11. A method comprising:
receiving, via a computing device, invoice data from a merchant;
identifying, via a computing device processor, a user based on the invoice data, wherein the user is associated with a payment;
sending information associated with the invoice data to the user and receiving payment instructions from the user, wherein the payment instructions include an alias; and
determining, via a computing device processor, that the merchant is a registered payment recipient based on the alias.

12. The method of claim 11, further comprising:
determining, via a computing device processor, that the user owes the merchant a payment amount;
presenting an invitation to the user to transfer a payment amount to the merchant; and
communicating, via computing device, a payment notification to the merchant.

13. The method of claim 11, further comprising:
determining, via a computing device processor, that the merchant owes the user a payment amount;
receiving payment instructions from the merchant, wherein the payment instructions include an alias associated with the user;
determining, via a computing device processor, that the user is a registered payment recipient based on the alias; and
communicating, via a computing device, a payment notification to the user.

14. The method of claim 13, wherein the payment amount is associated with a rebate amount that is owed to the user.

15. The method of claim 11, wherein the payment instructions comprise a payment amount, the method further comprising determining that the payment amount is below a maximum amount.

16. The method of claim 11, the method further comprising determining that the alias is associated with one or more accounts.

17. The method of claim 16, further comprising transferring a payment amount to the one or more accounts.

18. The method of claim 11, wherein the alias comprises an identifier selected from the group consisting of: a mobile telephone number, an email address, a social networking ID, a name, an address, a URL address, a logo, a brand, a picture, graphical art, a trade name, a trade mark, or combinations thereof.

19. A method of claim 11, the method comprising:
converting, via a computing device processor, the invoice data into an electronic bill;
sending the electronic bill to the user; and
transferring a payment to one or more accounts associated with the merchant.

20. A computer program product, the computer program product comprising a computer-readable medium having computer-executable instructions for performing:
storing an alias for a merchant in a storage device;
storing at least one invoice associated with the merchant in a storage device, where the invoice is directed for payment by a user; and
associating the alias of the merchant with the at least one invoice, such that a payment may be remitted to the merchant by reference to the alias.

21. The computer program product of claim 20, wherein the computer-executable instructions further perform:
receiving payment instructions from the user, wherein the payment instructions include the alias for the merchant.

22. The computer program product of claim 20, wherein the computer-executable instructions further perform:
determining that the merchant is a registered payment recipient based on the alias; and
communicating a payment notification to the payment recipient based on the payment recipient being the registered payment recipient.

23. The computer program product of claim 20, wherein the computer-executable instructions further perform:
transmitting information associated with the invoice to the user;
receiving payment instructions from the user, wherein the payment instructions include the alias for the merchant; and
applying the payment to the invoice.

24. The computer program product of claim 20, wherein the at least one invoice comprises a bar code.

25. The computer program product of claim 24, wherein the computer-executable instructions further perform:
scanning the bard code; and
retrieving data from the at least one invoice based on the bar code.

26. The computer program product of claim 20, wherein the computer-executable instructions further perform:
matching the alias with an account associated with the merchant; and
transferring a payment amount to the account.

27. The computer program product of claim 20, wherein the alias comprises an identifier selected from the group consisting of: a mobile telephone number, an email address, a social networking ID, a name, an address, a URL address, a logo, a brand, a picture, graphical art, a trade name, a trade mark, or combinations thereof.

28. The computer program product of claim 20, wherein the payment instructions comprise a payment amount.

29. The computer program product of claim 28, wherein the computer-executable instructions further perform:
determining that the payment amount is below a maximum amount; and
communicating a payment notification to the merchant, wherein the payment notification comprises the payment amount.

30. The computer program product of claim 20, wherein the computer-executable instructions further perform:
determining that one or more account are associated with the alias;
tracking payment transfers associated with the one or more accounts; and
storing records of the payment transfers in the storage device

31. A system for electronic invoicing and payment comprising:
a computer apparatus including a processor and a memory; and
an electronic billing software module stored in the memory, comprising executable instructions that when executed by the processor cause the processor to:
store an alias for a merchant in a storage device;
store at least one invoice associated with the merchant in a storage device, where the invoice is directed for payment by a user; and
associate the alias of the merchant with the at least one invoice via a computing device processor, such that a payment may be remitted to the merchant by reference to the alias.

32. The system of claim 31, wherein the module is further configured to:
receive payment instructions from the user, wherein the payment instructions include the alias for the merchant.

33. The system of claim 31, wherein the module is further configured to:
determine that the merchant is a registered payment recipient based on the alias;
communicate a payment notification to the merchant based on the merchant being the registered payment recipient; and
apply the payment to the invoice.

34. The system of claim 31, wherein the at least one invoice comprises an electronic invoice associated with the user.

35. The system of claim 34, wherein the module is further configured to:
transmit the electronic invoice to the user;
receive payment instructions from the user, wherein the payment instructions include the alias for the merchant; and
apply the payment to the invoice.

36. The system of claim 35, wherein the electronic invoice comprises data selected from the group consisting of: product identification; quantity of items ordered; price of each item; fees for services or products; tax amounts; total amount due; date payment is due; payment history; explanation of fees; explanation of services; shipping information; or combinations thereof.

37. The system of claim 31, wherein the module is further configured to:
match the alias with one or more accounts associated with the merchant; and
transfer a payment amount to the one or more accounts.

38. The system of claim 37, wherein the module is further configured to:
determine that the payment amount is below a maximum amount.

39. The system of claim 31, wherein the alias comprises an identifier selected from the group consisting of: a mobile telephone number, an email address, a social networking ID, a name, an address, a URL address, a logo, a brand, a picture, graphical art, a trade name, a trade mark, or combinations thereof.

40. A computer program product, the computer program product comprising a computer-readable medium having computer-executable instructions for performing:
receiving invoice data from a merchant;
identifying a user based on the invoice data, wherein the user is associated with a payment;
sending information associated with the invoice data to the user and receiving payment instructions from the user, wherein the payment instructions include an alias; and
determining that the merchant is a registered payment recipient based on the alias.

41. The computer program product of claim 40, wherein the computer-executable instructions further perform:
determining that the user owes the merchant a payment amount;
presenting an invitation to the user to transfer a payment amount to the merchant; and
communicating a payment notification to the merchant.

42. The computer program product of claim 40, wherein the computer-executable instructions further perform:
determining that the merchant owes the user a payment amount;
receiving payment instructions from the merchant, wherein the payment instructions include an alias associated with the user;
determining that the user is a registered payment recipient based on the alias; and
communicating a payment notification to the user.

43. The computer program product of claim 40, wherein the computer-executable instructions further perform:
receiving at least one invoice from a merchant, the at least one invoice comprising a bar code;
scanning the bar code; and
retrieving invoice data from the invoice based on the bar code.

44. The computer program product of claim 42, wherein the payment amount is associated with a rebate amount that is owed to the user.

45. The computer program product of claim 40, wherein the payment instructions comprise a payment amount, wherein the computer-executable instructions further perform:
determining that the payment amount is below a maximum amount.

46. The computer program product of claim 40, wherein the computer-executable instructions further perform:
determining that the alias is associated with one or more accounts.

47. The computer program product of claim 46, wherein the computer-executable instructions further perform:
transferring a payment amount to the one or more accounts.

48. The computer program product of claim 40, wherein the invoice comprises data selected from the group consisting of: product identification; quantity of items ordered; price of each item; fees for services or products; tax amounts; total amount due; date payment is due; payment history; explanation of fees; explanation of services; shipping information; or combinations thereof.

49. The computer program product of claim 40, wherein the alias comprises an identifier selected from the group consisting of: a mobile telephone number, an email address, a social networking ID, a name, an address, a URL address, a logo, a brand, a picture, graphical art, a trade name, a trade mark, or combinations thereof.

50. The computer program product of claim 40, wherein the computer-executable instructions further perform:
converting the invoice data into an electronic bill;
sending the electronic bill to the user; and
transferring a payment to one or more accounts associated with the merchant.

51. A system for electronic invoicing and payment comprising:
a computer apparatus including a processor and a memory; and
an electronic billing software module stored in the memory, comprising executable instructions that when executed by the processor cause the processor to:
receive invoice data from a merchant;
identify a user based on the invoice data, wherein the user is associated with a payment;
send information associated with the invoice data to the user and receive payment instructions from the user, wherein the payment instructions include an alias; and
determine that the merchant is a registered payment recipient based on the alias.

52. The system of claim 51, wherein the module is further configured to:
determine that the user owes the merchant a payment amount;
present an invitation to the user to transfer a payment amount to the merchant; and
communicate a payment notification to the merchant.

53. The system of claim 51, wherein the module is further configured to:
determine that the merchant owes the user a payment amount;
receive payment instructions from the merchant, wherein the payment instructions include an alias associated with the user;
determine that the user is a registered payment recipient based on the alias; and
communicate a payment notification to the user.

54. The system of claim 53, wherein the payment notification comprises at least a portion of the invoice data.

55. The system of claim 51, wherein the invoice comprises data selected from the group consisting of: product identification; quantity of items ordered; price of each item; fees for services or products; tax amounts; total amount due; date payment is due; payment history; explanation of fees; explanation of services; shipping information; or combinations thereof.

56. The system of claim 51, wherein the module is further configured to:
determine that the alias is associated with a registered bank account of the merchant.

57. The system of claim 51, wherein the alias comprises an identifier selected from the group consisting of: a mobile telephone number, an email address, a social networking ID, a name, an address, a URL address, a logo, a brand, a picture, graphical art, a trade name, a trade mark, or combinations thereof.

58. The system of claim 51, wherein the module is further configured to:
determine that the alias is associated with one or more accounts; and
transfer a payment amount to the one or more accounts.

59. The system of claim 51, wherein the module is further configured to:
receive at least one invoice from a merchant, the at least one invoice comprising a bar code;
scan the bar code; and
retrieve invoice data from the invoice based on the bar code.

60. The system of claim 51, wherein the module is further configured to convert the invoice data into an electronic bill;
send the electronic bill to the user; and
transfer a payment to one or more accounts associated with the merchant.
